(19) United States
(12) Patent Application Publication
(10) Pub. No.: US 2022/0270196 A1
(43) Pub. Date: Aug. 25, 2022

(54) SYSTEM AND METHOD FOR CREATING AND TRANSMITTING AN INCENTIVIZED OR MANDATED SERIOUS GAME SAFETY TEST TO OCCUPANTS OR USERS OF LIABLE PROPERTY IN AN ORGANIZATION

(71) Applicant: LOCI, INC., San Francisco, CA (US)

(72) Inventor: Samantha Mathews, San Francisco, CA (US)

(21) Appl. No.: 17/744,687

(22) Filed: May 15, 2022

Related U.S. Application Data
(63) Continuation-in-part of application No. 17/240,836, filed on Apr. 26, 2021.
(60) Provisional application No. 63/015,655, filed on Apr. 26, 2020.

(51) Int. Cl. G06Q 50/26

(52) U.S. Cl. CPC G06Q 50/265

(57) ABSTRACT

System and method for creating/executing an occupant safety test in a structure of an organization having a plurality of courses. The plurality of courses includes germ safe test, occupant exit test, and safety check test. The system adds contextual maps/diagrams corresponding to the physical zone and the fixtures in each zone of the structure. The system adds virtual fixtures/objects over the contextual maps/diagrams of the zone. The system attaches a game marker beside the virtual fixtures/objects. The game marker stores information corresponding to the virtual fixtures/objects for each of the germ safe test, occupant exit test, and safety check test. The system transmits the occupant safety test created to the occupant. The occupant executes the occupant safety test by identifying the game marker to get familiarized with corresponding physical location of the fixtures or safety equipment or incidents in the structure.

### CROSS-REFERENCE TO RELATED APPLICATIONS

This application claims priority to a U.S. application Ser. No. 17/240,836, filed Apr. 26, 2021, having Attorney Docket No. VENN001US0 and titled “SYSTEM AND A METHOD FOR CREATING AND TRANSMITTING AN OCCUPANT SAFETY TEST FOR OCCUPANTS IN AN ORGANIZATION” which claims priority to U.S. Provisional Patent Application No. 63/015,655, filed on Apr. 26, 2020; all of which are hereby incorporated by reference in their entirety.

### FIELD OF INVENTION

The present invention generally relates to providing safety tests to occupants or users of property belonging to an organization that is liable for training the safe and proper use of their property. More specifically, the present invention relates to a system and a method for creating and transmitting safety tests for occupants or users of property belonging to an organization such that an occupant or user can execute a safety course and test assigned to them and identify key fixtures and protocols for safe and proper use of the organization's property.

### BACKGROUND OF INVENTION

It is known that open markets, large organizations or facilities or buildings or transportation vessels or structures are designed to accommodate people in very large numbers. The facilities include, but are not limited to airplanes, cruise ships, passenger trains, manufacturing facilities, office buildings, shopping malls, schools, universities, hospitals and so on. Typically, the facilities include emergency exit doors in addition to entry and exit doors. The emergency exit doors are generally provided at strategic locations for allowing occupants of the structure or vessel to exit in case of an emergency situation. Further, the facilities include safety equipment such as first aid kit, life jackets, fire extinguisher, etc. placed at strategic locations for allowing the occupants to use in case of an emergency situation.

In addition, the facilities include audio alert systems, guidance systems having visual representations on walls of the facility, and lighting systems among others designed for guiding the occupants to nearest emergency exit doors. With advent in technology, sensors are deployed across the facility for tracking presence of the occupants and for guiding them to the nearest emergency exit doors. However, in an emergency situation, people tend to panic. It is scientifically proven that during stressful situations, parts of the prefrontal cortex involved in thought and reasoning begin to shut down. As a result, people may not react appropriately in the emergency situation and fail to use the property's safety equipment and follow the guidance systems.

Several systems have been disclosed in the past to provide guidance to users in a facility. One such example for providing directional indication is disclosed in a U.S. Pat. No. 9,754,466, entitled “Guidance indicator and system for providing egress assistance” (the “'466 Patent”). The '466 Patent discloses a system including a detector (113) configured to sense a condition, a guidance indicator (117) configured to provide an indication regarding a path for egress, and a control unit configured to control the guidance indicator based on a signal from the detector.

An example of a system utilizing sensors for guiding occupants is disclosed in a U.S. Pat. No. 9,761,096, entitled “Active emergency exit systems for buildings” (the “'096 Patent”). The '096 Patent discloses an active exit system including one or more active exit signs, each exit sign having at least one sensor, a display, and a transceiver. Each active exit sign monitors building environmental conditions, monitors the locations of users and objects within the building, and assists in location services during normal operation. The exit signs transmit a dynamic exit plan to a user's electronic device based on the user's location. In response to sensing an emergency event, the exit sign transmits an emergency signal to the user's electronic device and updates a user's exit plan as needed based on the location of the emergency event. The exit sign also transmits user location information to emergency responders.

An example of an emergency notification and response system linked to a fire alarm system is disclosed in a U.S. Pat. No. 8,884,772, entitled “Building evacuation system with positive acknowledgment” (the “'772 Patent”). The '772 Patent discloses an emergency notification and response system linked to a fire alarm system, a security system and to a communication network over which it sends and receives emergency messages to and from building occupants and to emergency response personnel. The emergency notification and response system comprises a notification module which operates to receive signals from a fire detection system and send one or more messages to building occupants to investigate the validity of a possible fire event, and to respond to the message with an indication that a fire event is in progress or not. Depending upon information received in the response, the notification module sends an evacuation message to a selected subset of the building occupants that includes instructions for evacuating the building.

An example of a system and a method for indicating an emergency exit path upon detection of a fire in a building structure is disclosed in a U.S. Pat. No. 9,983,011, entitled “Mapping and facilitating evacuation routes in emergency situations” (the “'011 Patent”). The '011 Patent discloses a system and method that include detecting a signal indicating presence of the fire in the building structure and determining an evacuation situation is present based on a risk assessment. In response to determining the evacuation situation is present, the systems and methods may include mapping the emergency exit path out of the building structure based on an identified location of the fire and an identified location of a person in the building structure, and operating a plurality of lighting devices in the building structure to indicate the emergency exit path out of the building structure.

Although the above-discussed systems are capable of alerting and guiding the occupants to the nearest emergency exit doors, they have few problems. For example, during an emergency situation such as a fire accident, the occupants tend to either ignore the alarm assuming it is a drill or alarm test or panic and forget safety protocols or guidance. In addition, due to smoke, the occupants may not be able to recognize the visual signals or lights indicating a path or route to the nearest emergency exit door. Further, there is no control over the number of people choosing to take a certain path for reaching the nearest emergency exit door which may result in a crowd running towards one emergency exit door. This may lead to unnecessary injuries or even death.

None of the above discussed prior art disclosures disclose a method for creating and transmitting a safety test for each occupant or user in an organization to familiarize the occupant or user with the fixtures and protocol in the area such that the occupant or user can maintain their safety with ease or may alert emergency personnel quickly which can save lives and resources of the organization.

Consequently, there is a need for an improved system and method for creating and transmitting incentivized or mandated safety test for occupants or users of liable property in an organization, such that the occupants or users are familiarized with areas, and safety fixtures and corresponding protocols to be followed to operate the fixtures and execute correct protocols in case of an emergency.

### SUMMARY

It is an object of the present invention to provide a system and a method for creating and transmitting incentivized or mandated safety tests for occupants or users of property in an organization that avoids the drawback of known techniques.

It is another object of the present invention to provide a system that creates and assigns a safety test for each occupant or user in accordance with their role within the organization or property. Occupants or users might have differing levels of responsibility depending on the location therefore requiring differing levels of familiarization For example, a guest is responsible for their own familiarization to safety protocols, while an employee or contractor is obligated with greater responsibility to their personal familiarization with the safety fixtures and protocols in an emergency situation to ensure theirs and others safety.

In order to achieve the object, the present invention provides a system and a method for creating and transmitting an incentivized or mandated safety test for each occupant or user of property of an organization such that the occupants can identify safety fixtures and protocols correctly corresponding to diagrams or visualizations of the property, executing the occupant safety test thereby familiarizing themselves with the fixtures and protocols in the area.

In one technical feature of the present invention, the system receives details of the organization. The organization may include several or many property types situated in one or more locations. As such, the system receives details of each location and property diagrams belonging to the organization. Each property further includes multiple zones or areas. Each of the zones or areas include several fixtures indicated in specific locations including safety equipment or an emergency door that is physically present in the zone or area. Accordingly, the system receives the details of the organization, the location and the areas as well as the fixtures within that area.

After receiving the details of the organization, the property, it's location and sub-areas or zones, the system creates an occupant safety test for each occupant or user of the property. The safety test is a test assigned to an occupant or user to identify a safety fixture affixed or imposed onto an area within the property diagram to indicate a physical fixture (location/equipment) and protocols to be followed in using/operating the fixtures associated within that property. The area plan indicates a digitized diagram of the area. Here, the area diagram is generated by superimposing safety fixtures and protocol over physical locations of the fixtures in the property area or zone. As specified above, a fixture indicates an area or subarea within the zone including safety equipment or an emergency door that is physically present in the area of the property. For example, the fixture includes a primary exit door, a secondary exit door, an area including a telephone, an area including a first aid kit, a muster station and so on. A safety fixture indicates a label or symbol affixed or imposed (superimposed) onto the area diagram used for identifying certain portions or component(s) i.e., the fixture in the area and it's proper use.

In accordance with the present invention, the system creates the safety test. The safety test indicates a test created for the occupant or user of an area of the property to identify safety features and protocols corresponding to the physical fixtures in the area of property in order to get familiarized with the physical location of the fixtures and corresponding protocols for use in an emergency situation. Here, the system creates the safety test personalized for the occupants or users in the area. By assigning the superimposed safety fixtures onto the area diagram to allow the occupant to identify the fixtures in the area, the system ensures that the occupant identifies the accurate physical location corresponding to the safety fixtures in the area. In other words, the system allows the occupants or users to get familiarized with the safety fixtures and operating instructions/protocols to operate the fixtures within the property so as to build a spatial map or cognitive map in the minds of the occupants or users to follow in an emergency situation.

After creating the occupant safety test, the system transmits the occupant safety test to the occupant. The occupant uses a user device to take or execute the occupant safety test. Specifically, the occupant executes the occupant safety test by identifying the safety fixtures on the zone plan of the zone displayed to him and familiarizes with the safety fixtures in the zone. For example, the system creates the occupant safety test for an occupant in a zone such that the occupant executes the occupant safety test e.g., watching a video including visual/audio instructions to operate the fixtures and to obtain full information about the fixtures present in the zone such that the occupant is trained or familiarized early on with the safety fixtures associated with the fixtures so as to follow in the emergency situation.

In one advantageous feature of the present invention, the system ensures that each occupant is familiarized with the fixtures and protocols in the zone or area of a property. The occupant follows the protocols and instructions based on the knowledge gained from the safety test in an emergency situation and reaches theirs and others' safety. This ensures their safety in the emergency situation and occupant(s)/user(s) can further alert emergency personnel to come to their aid.

In another technical feature of the present invention, the system creates a plurality of safety course templates that become localized with the organizational information. The plurality of course/test templates include but are not limited to a germ safety test template, an occupant exit test template, a touchless physical orientation to property emergency scenarios course template. Here, the germ safe test indicates a test created for ensuring hygiene of occupants in each area of a the property. The occupant exit test indicates a test created for ensuring occupant's familiarization of exits and musters related to the property. The safety check test indicates via QR code decals, scenarios that could happen at specific areas within the property, the occupant or user must resolve the incident scenarios by finding the closest appropriate safety fixtures/equipment and scanning the QR code resolution marker decal associated with the fixture.

The system localizes all safety test templates by adding contextual maps or diagrams corresponding to the physical areas and the fixtures in each area of the property. Further, the system adds virtual fixtures or objects over the contextual maps or diagrams of the areas. The system embeds a game marker within the virtual fixtures or objects. The game marker stores information corresponding to the virtual fixtures or objects for each of the course/test templates. The game marker can include a video, a photo, an incident-scenario chain as described in the safety check course template, a clickable polygon boundary, a checkpoint, a smart sticker decal (QR code decal, a Quick Response (QR) code, and a Uniform Resource Locator (URL). The system transmits the safety test created to the occupant or user of the property. The occupant/user uses their device or a device provided by the organization to execute the occupant safety test by identifying the game markers within the course/test proving they are familiarized with the possible incident scenarios and corresponding physical location of the fixtures or safety equipment and subsequent protocol for safe use and proper use of the property.

In one advantageous feature of the present invention, the system creates a serious game having levels for each of the germ safety test, the occupant exit test, and the safety check test. By creating levels as in the game, the occupant is prompted to get familiarized with the fixtures or safety equipment physically present in the structure. Further, the system assigns rewards upon the occupant/user successfully identifying the game marker at each level of the game and gives feedback for incorrect answers. This encourages the occupant/user to interact with the system and take different occupant safety tests. The system may also mandate a safety test to a user and block access to the property if the relevant safety test is not completed. These unique features ensure an enhanced level of care on behalf of the organization by ensuring each occupant/user they are liable for has interacted with the appropriate safety instructions for their property rather than just posting the instructions on the property or ensuring an occupant/user attended a training orientation without testing their abilities. The goal of the organization is to provide adequate training to each individual they are responsible for everyone that interacts with their property. As occupants/users complete safety tests, their organizational training score improves. The goal of an organization using the system is to achieve a 100% score, indicating that every person they are responsible for has received adequate training via completed safety tests and high occupant/user scores indicating their familiarity with safety fixtures physically present in the liable property and the associated behaviors required by protocols to follow in the event of an incident (e.g., identifying the first aid kit to help a coworker who is injured) or an emergency. (e.g., abandon ship protocols).

Features and advantages of the subject matter hereof will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present invention will become apparent from the following detailed description, taken in combination with the appended drawings, in which:

FIG. 1 illustrates an environment in which a system for creating and transmitting an occupant safety test is implemented, in accordance with one embodiment of the present invention;

FIG. 2 illustrates a diagrammatic representation of the system, in accordance with one embodiment of the present invention;

FIG. 3 illustrates a block diagram of a user device, in accordance with one embodiment of the present invention;

FIG. 4 illustrates a method of creating an occupant safety test for an occupant of an organization, in accordance with one embodiment of the present invention;

FIG. 5 illustrates a method of creating and transmitting or sending an occupant safety test to an occupant of an organization, in accordance with one embodiment of the present invention;

FIG. 6 illustrates an exemplary login page or dialog box prompted to an administrator by the system to login to the system, in accordance with one embodiment of the present invention;

FIG. 7 illustrates a screenshot showing a subsection when selected displays the details of the organization, in accordance with one embodiment of the present invention;

FIG. 8 illustrates the screenshot showing a subsection showing details of the occupant retrieved from main memory and displayed on the video display, in accordance with one embodiment of the present invention;

FIG. 9 illustrates a screenshot showing the administrator being prompted to add new location in subsection, in accordance with one exemplary embodiment of the present invention;

FIG. 10 illustrates the screenshot in which the system prompts the administrator to add or create new zone in subsection, in accordance with one exemplary embodiment of the present invention;

FIG. 11 illustrates an exemplary zone plan of the zone within the location upon which the safety fixtures are added, in accordance with one exemplary embodiment of the present invention;

FIG. 12 illustrates a screenshot showing subsections for assigning the location and zone to an occupant, in accordance with one exemplary embodiment of the present invention;

FIG. 13 illustrates an example in which the occupant safety test is created and sent to the occupant, in accordance with one exemplary embodiment of the present invention;

FIG. 14 illustrates a method of receiving and executing the occupant safety test by the occupant, in accordance with one exemplary embodiment of the present invention;

FIG. 15 illustrates an exemplary login page or dialog box prompted to the occupant to login to the system to access the link or email, in accordance with one exemplary embodiment of the present invention;

FIG. 16 illustrates a screenshot showing a subsection, displaying the occupant safety test in which the occupant is prompted to identify the safety fixtures in the zone, in accordance with one exemplary embodiment of the present invention;

FIG. 17 illustrates a block diagram of a system for creating an occupant safety test, in accordance with another embodiment of the present invention;

FIG. 18 illustrates a method of creating occupant safety test and attaching fixtures or objects on a floor map, in accordance with one embodiment of the present invention;

FIG. 19 illustrates an exemplary screenshot showing checklist prior to creation of the occupant safety test;

FIG. 20 illustrates an exemplary screenshot showing adding zone details;

FIG. 21 illustrates an exemplary screenshot showing adding safety features to a zone;

FIG. 22 illustrates an exemplary screenshot showing placing safety incidents on the map;

FIGS. 23A through 23E illustrate exemplary screenshots showing creation of different safety incidents;

FIG. 24 illustrates an exemplary screenshot showing placing fixtures on the floor map of the zone;

FIG. 25 illustrates a method of executing an occupant safety test by an occupant, in accordance with one embodiment of the present invention;

FIG. 26 illustrates an exemplary environment in which an occupant scans fixtures to execute the occupant safety test;

FIGS. 27A and 27B illustrate exemplary screenshots showing the occupant taking the test;

FIGS. 28A through 28D illustrate exemplary screenshots showing the occupant taking the test, in accordance with one embodiment of the present invention;

FIGS. 29A through 29D illustrate exemplary screenshots showing the occupant taking the test, in accordance with another embodiment of the present invention; and

FIGS. 30A through 30H illustrate exemplary screenshots showing the occupant taking the test, in accordance with another embodiment of the present invention.

It will be noted that throughout the appended drawings, like features are identified by like reference numerals.

### DETAILED DESCRIPTION OF THE EMBODIMENTS

Before the present features and working principle of a system for creating and transmitting an occupant safety test is described, it is to be understood that this invention is not limited to the particular system as described, since it may vary within the specification indicated. Various features of the system for creating and transmitting an occupant safety test might be provided by introducing variations within the components/subcomponents disclosed herein. It is also to be understood that the terminology used in the description is for the purpose of describing the particular versions or embodiments only, and is not intended to limit the scope of the present invention, which will be limited only by the appended claims. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It should be understood that the present invention describes a system and a method for creating and transmitting an occupant safety test in an organization. The system receives details of an organization. The organization might be present in multiple locations. As such, the system receives details of each location of the organization. Further, each location includes multiple zones. Each zone of the multiple zones includes fixtures. A fixture indicates an area or subarea within the zone including safety equipment or emergency door that is physically present in the zone. The system receives a list of occupants in each zone in the location. Further, the system creates an occupant safety test for each occupant in the zone, by assigning a safety fixture onto to a zone plan of the zone, the safety fixture being indicative of a superimposed label/image/diagram of a fixture in the zone, that the occupant has to identify when executing the occupant safety test. After creating the occupant safety test, the system transmits the occupant safety test to the occupant. The user uses a user device to execute the occupant safety test by identifying the safety fixtures on the zone plan of the zone thereby familiarizing with the fixtures in the zone.

Further, the present invention describes a system and a method for creating and executing an occupant safety test in a structure of an organization. The system creates an occupant safety test having a plurality of courses. The plurality of courses includes a germ safe test, an occupant exit test, a safety check test. The system adds contextual maps or diagrams corresponding to the physical zone and the fixtures in each zone of the structure. The system adds virtual fixtures or objects over the contextual maps or diagrams of the zone. The system attaches a game marker beside the virtual fixtures or objects. The game marker stores information corresponding to the virtual fixtures or objects for each of the germ safe test, the occupant exit test, and the safety check test. The system transmits the occupant safety test created to the occupant. The occupant executes the occupant safety test by identifying the game marker to get familiarized with corresponding physical location of the fixtures or safety equipment or incidents in the structure.

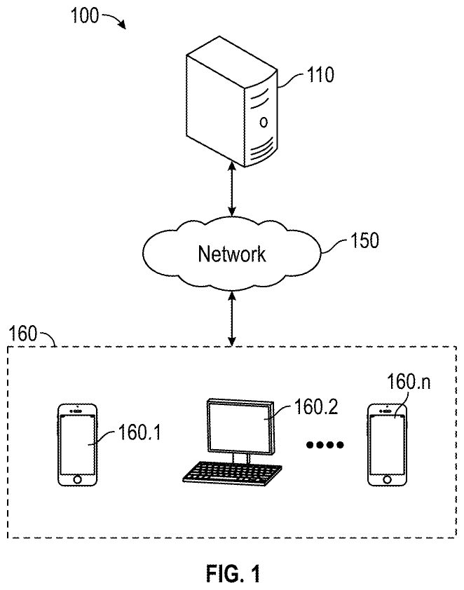

Various features and embodiments of the system for creating, transmitting and executing an occupant safety test are explained in conjunction with the description of FIGS. 1-30H.

In one embodiment, the present invention discloses a system for creating and transmitting an occupant safety test. FIG. 1 shows environment 100 in which system 110 is implemented. Environment 100 includes system 110, and plurality of user devices 160.1, 160.2 . . . 160.n collectively referred as user devices 160 or simply user device 160. As can be seen, system 110 and user devices 160 communicatively connect to each other via network 150.

System 110 includes an electronic device such as a mobile phone, a laptop, a tablet, a computer and so on. System 110 presents hardware and/or one or more applications configured to execute functions for creating an occupant safety test for occupants in an organization. In one embodiment, system 110 implements as a standalone device or connects (e.g., networked) to other systems via network 150. In another embodiment, system 110 implements as a client-server architecture, in that system acts as a server 110 and communicates with one or more client or user devices 160 over network 150.

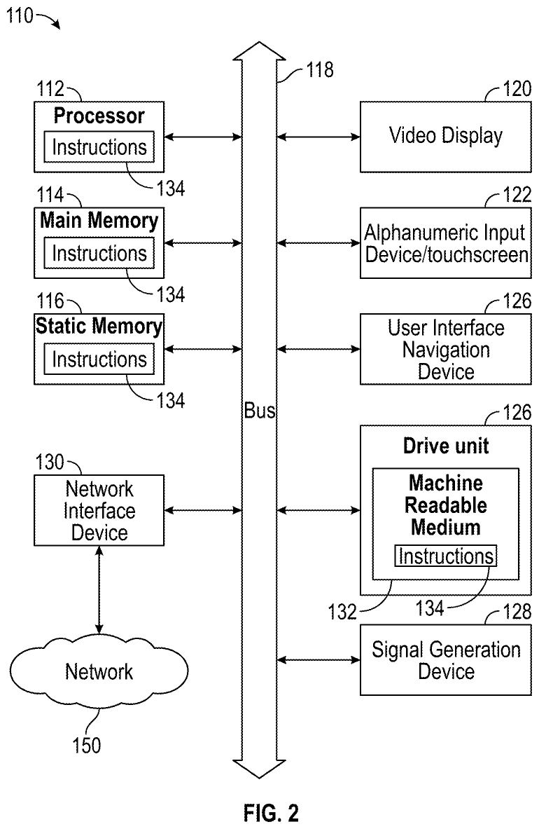

FIG. 2 shows a diagrammatic representation of system 110, in accordance with one embodiment of the present invention. System 110 includes processor 112 (e.g., a central processing unit (CPU), graphics processing unit (GPU) or both), main memory 114 and static memory 116, which communicate with at least one other via bus 118.

Processor 112 includes any suitable processing device, such as a microprocessor, microcontroller, integrated circuit, logic device, or other suitable processing device.

Main memory 114 includes one or more computer-readable media, including, but not limited to, non-transitory computer-readable media, RAM, ROM, hard drives, flash drives, or other memory devices. Main memory 114 stores information accessible by processor 112, including computer-readable instructions 134 that are executed by processor 112. Instructions 134 include any set of instructions that when executed by processor 112, cause processor 112 to perform operations.

In one example, main memory 114 stores data that can be retrieved, manipulated, created, or stored by processor 112. The data includes, for instance, organizational data, occupants' data, zone data, and other data.

Bus 118 provides a mechanism for letting the various components and subsystems of system 110 communicate with each other as intended. Although bus 118 is shown schematically as a single bus, alternative embodiments of bus 118 utilizes multiple buses. Bus 118 includes any of several types of bus structures including a memory bus or memory controller, a peripheral bus, and a local bus using any of a variety of bus architectures. For example, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

System 110 includes video display unit 120 (e.g., a liquid crystal display (LCD) or a cathode ray tube (CRT)). System 110 further includes an alphanumeric input device (e.g., a keyboard) and/or touchscreen 122, user interface (UI) navigation device 124 (e.g., a mouse), disk drive unit 126, signal generation device 128 (e.g., a speaker), and network interface device 130.

Disk drive unit 126 includes machine-readable medium 132 on which is stored one or more sets of instructions and data structures (e.g., software 134) embodying or utilized by any one or more of the methodologies or functions described herein. It should be understood that the term “machine-readable medium” includes a single medium or multiple media (e.g., a centralized or distributed database, and/or associated caches and servers) that stores the one or more sets of instructions. The term “machine-readable medium” includes any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” may accordingly be taken to include, but not be limited to, solid-state memories, optical and magnetic media, and carrier wave signals.

Instructions 134 resides, completely or at least partially, within main memory 114 and/or within processor 112 during execution thereof by system 110, main memory 114 and processor 112 also constituting machine-readable media. Instructions 134 get transmitted or received over network 150 via network interface device 130 utilizing any one of a number of well-known transfer protocols.

System 110 exchanges data with user devices 160 over network 150, as shown in FIG. 1. A person skilled in the art understands that plurality of user devices 160 includes one or any number of user devices 160 that connect to system 110 over network 150. Each of user devices 160 indicates a suitable type of computing device, such as a general purpose computer, special purpose computer, laptop, desktop, mobile device, navigation system, smartphone, tablet, wearable computing device, a display with one or more processors, or other suitable computing device. For instance, in some implementations, user device 160 includes a mobile user device, or a non-mobile user device.

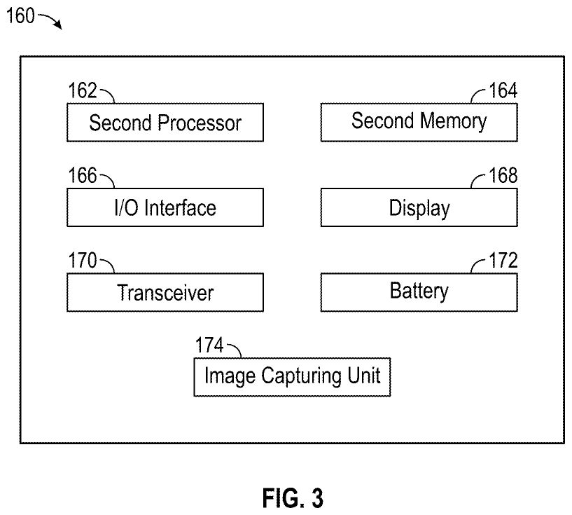

Similar to system 110, each of user devices 160 includes second processor 162 and second memory 164, as shown in FIG. 3. Second processor 162 encompasses a central processing unit (CPU), a graphic processing unit (GPU) dedicated to efficiently rendering images or performing other specialized calculations, and/or other processing devices. Second memory 164 includes a computer-readable media that stores information accessible by processor 162, including instructions that can be executed by processor 162 and data.

User device 160 further includes various input/output devices for providing and receiving information from a user, such as a touch screen, touch pad, data entry keys, speakers, and/or a microphone suitable for voice recognition. For instance, user device 160 includes an input/output interface 166 and display 168. Display 168 presents a user interface configured for displaying information such as a zone plan of a zone and affixing or imposing safety fixtures onto the zone plan of the zone according to example aspects of the present disclosure.

User device 160 includes a network interface such as transceiver 170 used for communicating with one or more remote computing devices (e.g. system 110) over network 150. Further, user device 160 includes battery 172 such as a rechargeable battery for powering user device 160.

User device 160 further includes a network interface such as image-capturing unit 174 such as a camera used for capturing still images or video. A person skilled in the art understands that image-capturing unit 174 helps to scan codes such as a Quick Response (QR) code. Image-capturing unit 174 scans the QR code and transmits the information to second processor 162 for processing the information.

Network 150 includes any type of communications network, such as a local area network (e.g. intranet), wide area network (e.g. Internet), cellular network, or some combination thereof. Network 150 includes a direct connection between user device 160 and system 110. In general, the communication between system 110 and user device 160 can be carried via a network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of the ordinary skilled in the art will recognize that the inherent flexibility of computer-based systems allows for a great variety of possible configurations, combinations, and divisions of tasks and functionality between and among components. For instance, system or server processes discussed herein may be implemented using a single server or multiple servers working in combination. Data and the applications might be implemented on a single system or distributed across multiple systems. Distributed components may operate sequentially or in parallel.

In accordance with one embodiment of the present invention, system 110 creates and transmits an occupant safety test for an occupant in an organization. As such, an administrator or an owner of the organization operates system 110. In order to operate system 110, the administrator registers himself with system 110. For instance, the administrator registers himself by providing his details such as Name, Email address, telephone number and so on. After providing the details, system 110 prompts the administrator to provide a password to securely authenticate him to access system 110. After providing the email address and password, system 110 registers the details of the administrator. Specifically, processor 112 receives the details of the administrator and instructs main memory 114 to store the details.

In the current embodiment, the organization includes, but not limited to, a hospital, a manufacturing facility, a school, an office building, a university, a shopping mall and so on. As known, the organization situates in one or more locations. In accordance with current embodiment, a location indicates a building or structure or vehicle belonging to the organization. In each location, the organization includes multiple zones. In other words, a location indicates a building/structure/vehicle belonging to an organization that contains multiple zones. For example, consider an organization named Seaspan is located in Vancouver with an address 50 Pemberton Avenue, then in accordance with current embodiment, Seaspan is the organization and 50 Pemberton is the location. Further, the location includes multiple zones e.g., Zone 2A, Zone 2B, etc. in which a location is subdivided into multiple smaller sections/locations of manageable size based on the occupancy capacity of the occupants in the organization. The zones are created based on several factors such as occupancy rate, airflow, area in square footage, type of occupants or machinery to be used, etc. A person skilled in the art understands that zones are created based on any other factors, including, but not limited to, size of the location, number of occupants in the location at any given point of time and/or as needed by the organization.

Each of the zones includes one or more fixtures. A fixture indicates an area including safety equipment or emergency door or safety room or safety section that is physically present in the zone. For example, Zone 2A includes fixtures such as a primary exit door, a secondary exit door, an area including a telephone, an area including a first aid kit, a muster station and so on. Similarly, Zone 2B includes fixtures such as a primary exit door, an area including a telephone, an area including a first aid kit, and so on. Each of the zones including the fixtures are digitized as an index (Application programming interface (API) index), in that a zone plan of the zone is digitized and markings/safety fixtures are affixed or superimposed onto the zone plan accurately marking the physical location of the fixtures in the zone. A person skilled in the art understands that the zone plan indicates a digitized floor plan of the zone. Here, system 110 generates or creates the zone plan by superimposing the safety fixtures corresponding to the physical location of the fixtures in the zone. The zone plan including the safety fixtures is then provided to the occupant of the zone to identify the physical fixtures with ease. In other words, the physical fixtures are mapped onto a zone plan of the zone with markings or safety fixtures such that the occupants get familiarized in identifying the physical fixtures in the zone with the help of the safety fixtures on the zone plan. Each safety fixture is assigned with longitude and latitude coordinates and logged into the map. Further, each of the safety fixtures is tagged with information such as location of the fixture and protocol that needs to be followed by an occupant in operating the fixture. This is done to allow the occupant to interact with system 110 to obtain more information such as diagrams, maps, etc. corresponding to the fixtures in the zone.

An occupant indicates a person being employed or present in one or more zones in a location of the organization. In one example, the occupant indicates an employee of the organization assigned with a designated workstation to perform a designated task. In another example, the occupant indicates a visitor to the zone for a specific duration.

In order to familiarize the occupant with the fixtures in the zone, the present invention facilitates in creating an occupant safety test for the occupant. The occupant safety test is specifically configured for each occupant or a plurality of occupants present in a zone in a location. The occupant safety test is a test created specifically for an occupant in a zone to identify a safety fixture affixed or superimposed on a zone plan of the zone to indicate a physical fixture in the zone. The safety fixture indicates a label or symbol on the zone plan used for identifying certain portions or components i.e., fixtures in the zone. For example, consider that a first aid kit symbol or image is affixed on the zone plan to indicate the location of the first aid kit in the zone. Further, a telephone symbol is affixed on the zone plan to indicate the location of the telephone in the zone. Further, a muster station symbol or image is affixed on the zone plan to indicate the location of the muster station in the zone. Similarly, other safety fixtures are affixed onto the zone plan to indicate different safety locations in the zone.

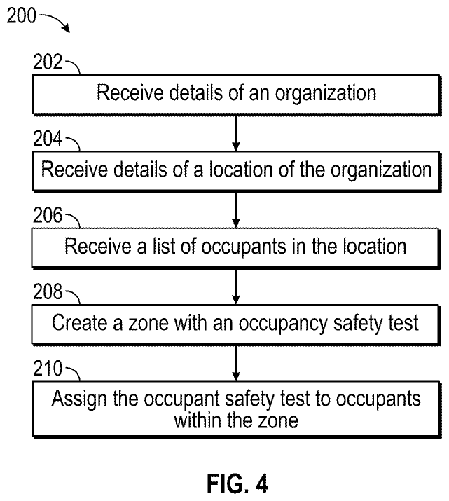

A method of creating an occupant safety test for an occupant of an organization is explained using FIG. 4. FIG. 4 illustrates method 200 of creating an occupant safety test for an occupant of an organization, in accordance with one embodiment of the present invention. The order in which method 200 is described should not be construed as a limitation, and any number of the described method blocks can be combined in any order to implement method 200 or alternate methods. Additionally, individual blocks may be deleted from method 200 without departing from the spirit and scope of the subject matter described herein. Furthermore, method 200 can be implemented in any suitable hardware, software, firmware, or combination thereof. However, for ease of explanation, in the embodiments described below, method 200 implements using the above-described system 110.

In order to create an occupant safety test for an occupant in an organization, at first, system 110 receives details of the organization, as shown at step 202. For example, system 110 receives details of the organization such as the name of the organization. Further, if the organization includes a plurality of sub-organizations indicating subsidiaries of the organization situated at different locations, then system 110 receives the details of each of the locations of the organization, as shown at step 204.

As presented above, the organization situates in one or more locations, say as subsidiaries or spread out as multiple branches. As such, if the organization is present in more than one location, then system 110 receives details of the organization for each of the locations. In accordance with present embodiment, a location indicates a building or structure or vehicle belonging to the organization.

After receiving the details of the organization and the locations, system 110 receives a list of occupants in the location, as shown at step 206. As specified above, the occupant indicates a person employed or present in the structure of the organization. For each of the occupants, system 110 receives the occupant's name, identification number (ID) such as an employee ID, name of a department in which the occupant is assigned or designated to work and so on. After receiving the list of the occupants, system 110 configures with knowledge of protocols to be followed in each zone of the location where the occupant is designated to perform his assigned task. Subsequently, system 110 assigns the protocols to be followed in each zone of the location where the occupant is designated to perform his assigned task, as shown at step 208. As presented above, the location is divided into multiple zones for easy identification of one or more departments or sections in which a variety of tasks are performed by the occupants. In other words, a zone is indicative of an area within the location of the organization in which an occupant performs a given task. Here, the occupant performs the same or different tasks in one location. Alternatively, the occupant performs the same or different tasks in one location.

After receiving the details of each occupant, system 110 creates a zone with an occupant safety test for the occupant, as shown at step 208. In other words, system 110 creates the occupant safety test for each of the occupants in a zone. As such, system 110 creates different occupant safety tests for occupants in different zones.

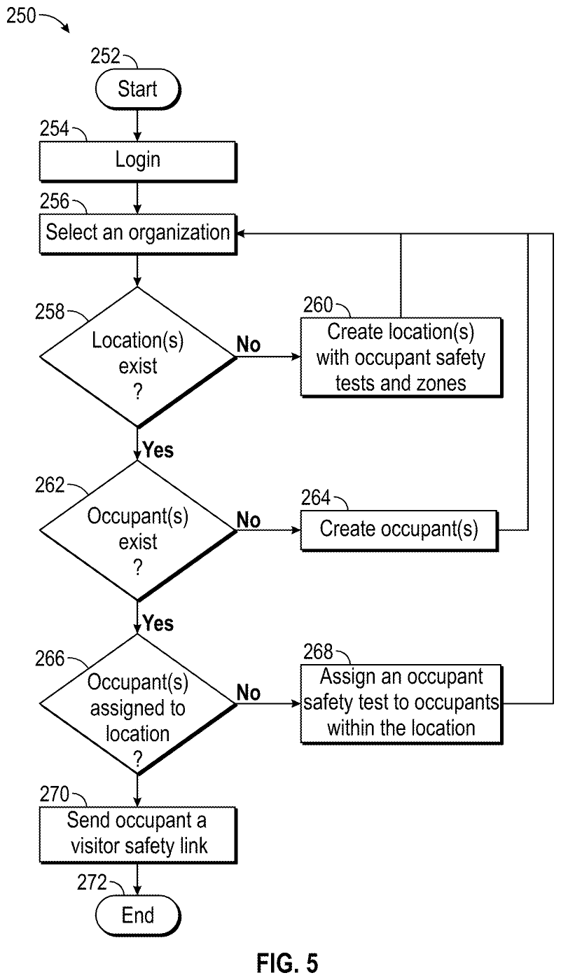

Further, system 100 assigns the occupant safety test created for the occupants within the zone, as shown in step 210. It should be understood that system 110 assigns the occupant safety test to each of the occupants in each of the zones in the location. Creation of the occupant safety test and assigning the occupant safety test to an occupant to identify a safety fixture affixed onto a zone plan of the zone is explained in detail in the later part of the description with the help of FIG. 5.

After assigning the occupant safety test for each occupant in the zone of the location belonging to the organization, information corresponding to the location, zone and the occupant safety test get stored in main memory 114 of system 110. Although it is presented that details of one organization present different locations, each location including multiple zones is received and stored in main memory 114, it should be understood that the above process is repeated for receiving details from more than one organization and the details are stored in main memory 114.

Now referring to FIG. 5, method 250 of creating and transmitting or sending an occupant safety test to an occupant of an organization is explained, in accordance with one embodiment of the present invention. The order in which method 250 is described should not be construed as a limitation, and any number of the described method blocks can be combined in any order to implement method 250 or alternate methods. Additionally, individual blocks may be deleted from method 200 without departing from the spirit and scope of the subject matter described herein. Furthermore, method 250 can be implemented in any suitable hardware, software, firmware, or combination thereof. However, for ease of explanation, in the embodiments described below, method 250 implements using the above-described system 110.

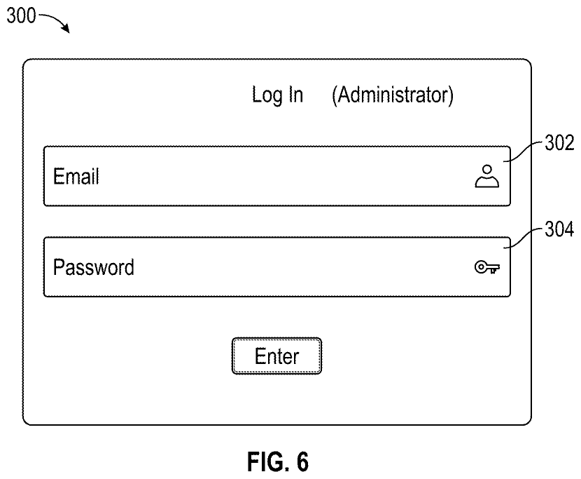

Method 250 begins at step 252. In order to create an occupant safety test for an occupant, system 110 prompts the administrator to login to system 110 by providing his email address and the password registered with system 110, as shown at step 254. FIG. 6 shows an exemplary login page or dialog box 300 that system 110 prompts to the administrator. As can be seen, login page 300 includes subsections 302 and 304 for receiving the email address and password, respectively from the administrator. Upon being prompted, the administrator provides his email address and password registered with system 110. After receiving the email address and password, processor 112 verifies the email address and password with the email address and password stored in main memory 114. If the email address and password match, then system 110 provides access to the administrator.

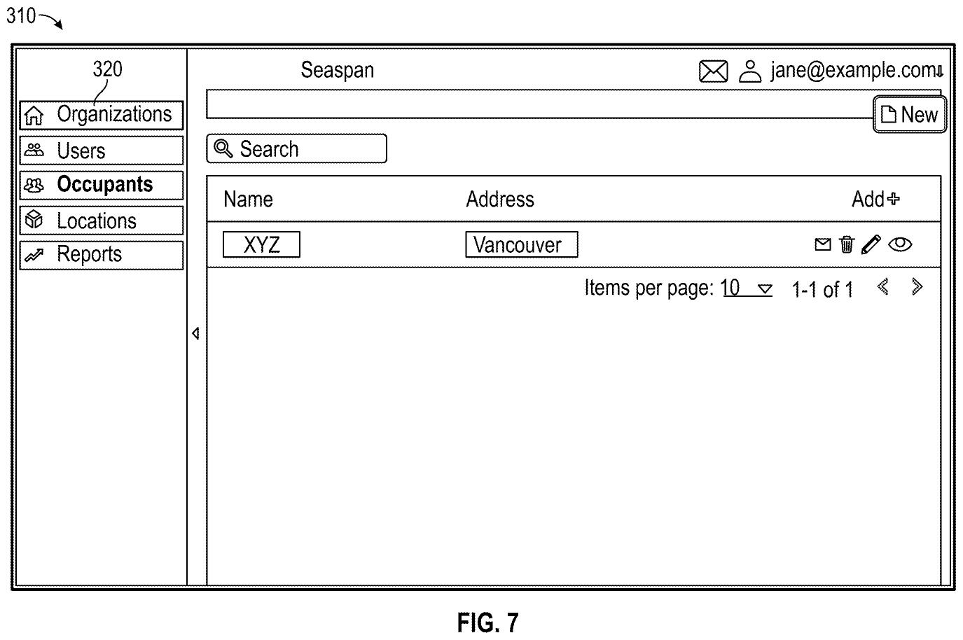

After accessing system 110, system 110 allows the administrator to select an organization from a list of organizations stored in main memory 114, as shown at step 256. As specified above, system 110 stores the details of organizations in main memory 114. As such, the administrator provides an input i.e., name of the organization in system 110 using alphanumeric input device and/or touchscreen 122. After receiving the input, system 110 retrieves the details of the organization from main memory 114. FIG. 7 shows screenshot 310 encompassing subsection 312 that displays the details of the organization upon selection. As can be seen, system 110 displays the name of the organization and address of the organization.

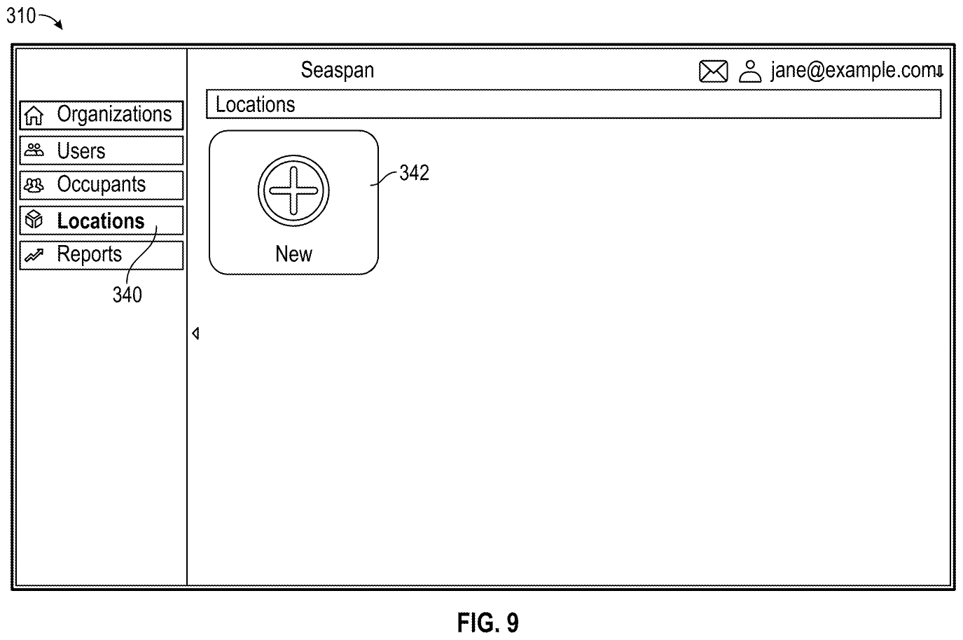

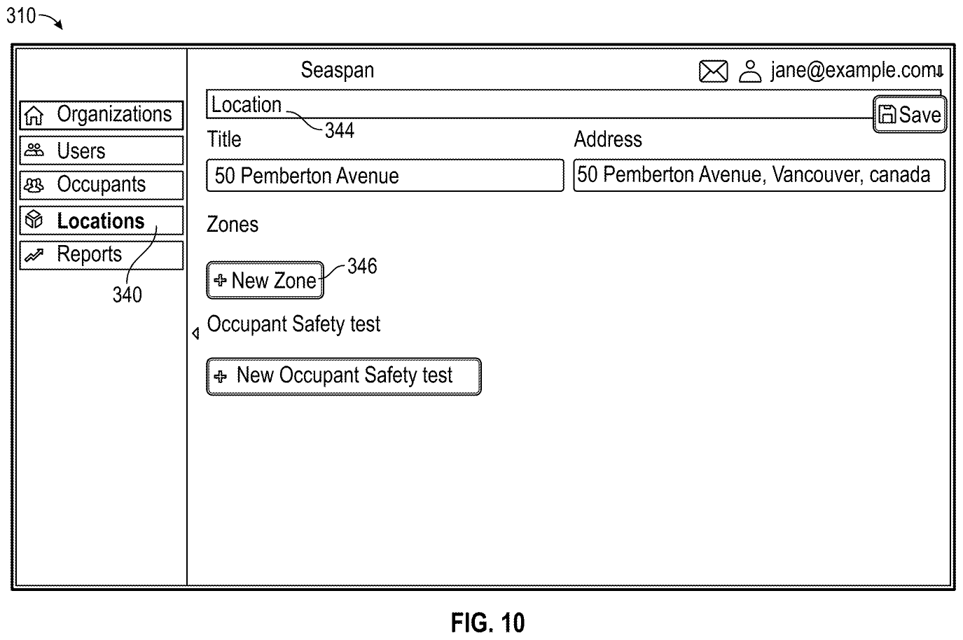

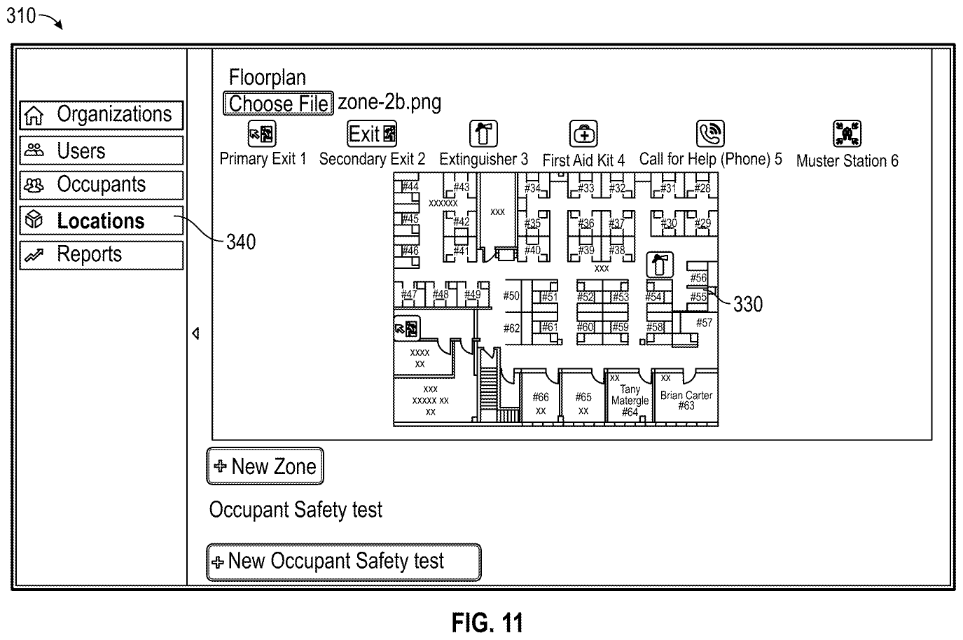

After selecting the organization at step 256, method 250 moves to step 258. At step 258, system 110 checks if the location of the occupant is added. If the location of the occupant is not added in system 110, then system 110 prompts the administrator to create a new location for the occupant, as shown at step 260. FIG. 9 shows screenshot 310 having subsection 342. Here, system 110 prompts the administrator to add a new location in subsection 342. Specifically, system 110 prompts the administrator to add the new location by entering the name and address of the physical location for the occupant. After adding the location, system 110 prompts the administrator to create zones with fixtures within the location subsection 340 to identify the fixtures in the zone. FIG. 10 illustrates screenshot 310 in which system 110 prompts the administrator to add or create a new zone in subsection 346. In order to create the zone, the administrator adds a nomenclature or name for the zone. Further, the administrator gets prompted to upload a zone plan of the zone. After uploading the zone plan, system 110 prompts the administrator to drag and drop safety fixtures onto the zone plan. As specified above, the safety fixture indicates a label or symbol affixed or imposed onto the zone plan used for identifying certain portions or components in the zone e.g., the exit doors, first aid kit and so on. FIG. 11 shows an exemplary zone plan of the zone within the location upon which the safety fixtures are added. Here, the administrator drags and drops a safety fixture indicating an emergency exit onto the zone plan. Similarly, the administrator drags and drops other safety fixtures for mapping location of fixtures such as a primary exit, a secondary exit, an extinguisher, a first aid kit, call for help, a muster station and so on.

In one implementation, the safety fixtures are attached with a video such that the video is played to the occupant to identify the safety fixtures on the zone plan when the occupant takes the occupant safety test.

In another implementation, the safety fixtures are configured in the form of a Quick Response (QR) code such that the occupant can use image-capturing unit 174 of user device 160 to scan and retrieve the occupant safety test assigned to him to identify the safety fixtures on the zone plan indicating the fixtures in the zone.

If the details of the location exist in system 110 at step 258, then system 110 retrieves the details of the location, and method 250 moves to step 262. At step 262, system 110 checks if the location includes occupants. In other words, system 110 checks if the list of occupants is already present in main memory 114. If the list of occupants is not present indicating that details of the occupants of the organization are not added to system 110, then system 110 prompts the administrator to create or add a list of occupants, as shown at step 264. In order to create or add details of the occupant in system 110, the administrator provides the occupant's name, identification number (ID) such as an employee ID, name of a department in which the occupant is assigned or designated to work and so on. After adding the details of the occupant, method 250 returns to step 256. Further, if more occupants' details are to be added, then step 264 is repeated.

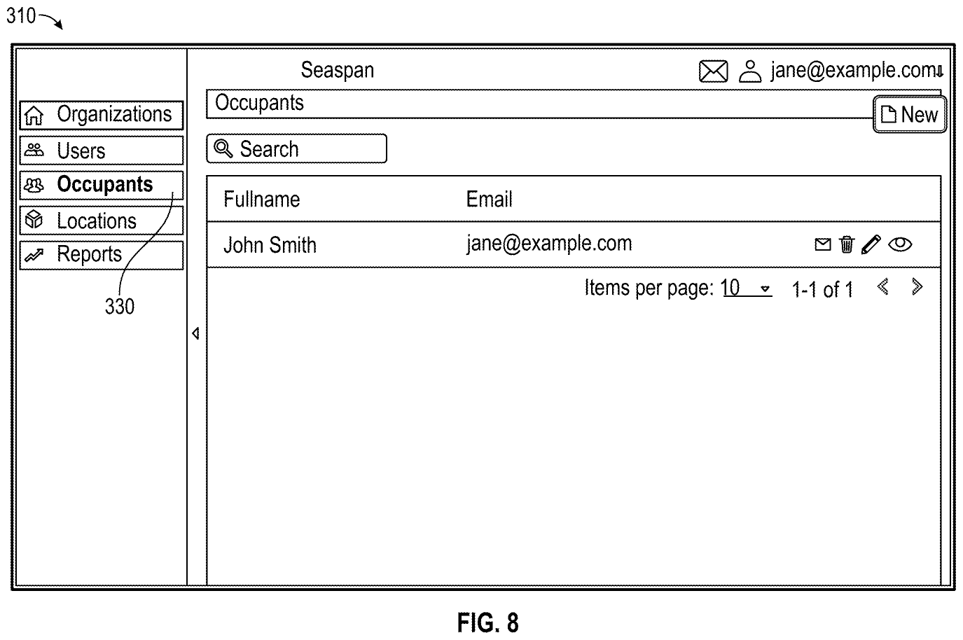

FIG. 8 illustrates screenshot 310 including subsection 330. Subsection 330 shows details of the occupant such as the name and email of the occupant retrieved from main memory 114 and displayed on the video display 120, in accordance with one exemplary embodiment of the present invention.

If the details of the occupants exist in system 110 at step 262, then method 250 moves to step 266.

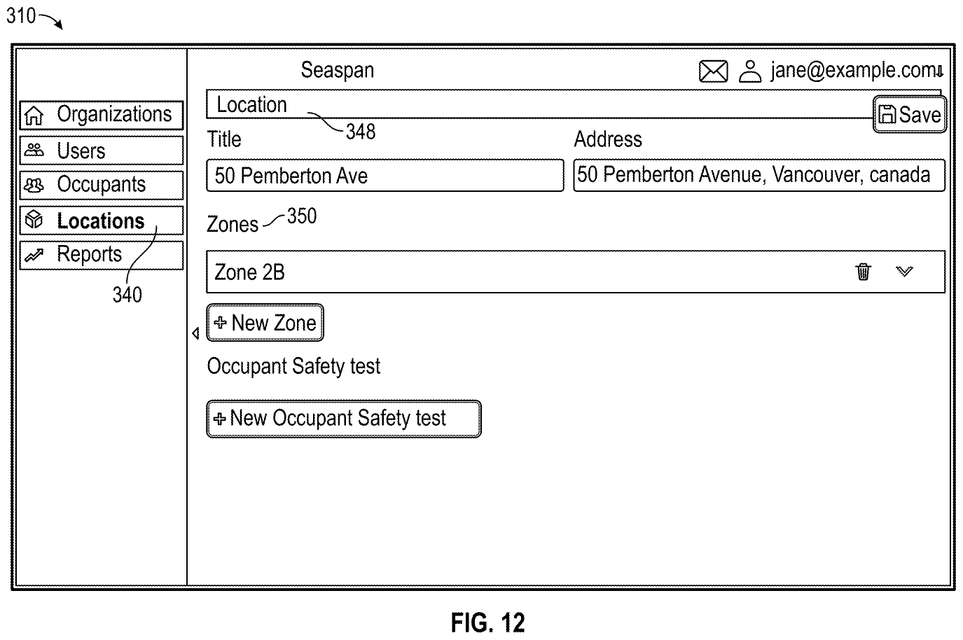

FIG. 12 shows screenshot 310 illustrating a location i.e., subsection 348 and zone i.e., subsection 350 assigned to an occupant. At step 266, system 110 checks if a zone and a location are assigned to the occupant. If the zone and the location are not assigned to the occupant, then system 110 creates an occupant safety test by assigning the occupant to a zone and location for creating the occupant safety test, as shown at step 268. In order to create the occupant safety test, the administrator selects the safety fixtures that the occupant should identify in the occupant safety test. For example, system 110 assigns the occupant to identify safety fixtures corresponding to a fixture such as a primary exit, a secondary exit, an extinguisher, a first aid kit, call for help, and a muster station and so on.

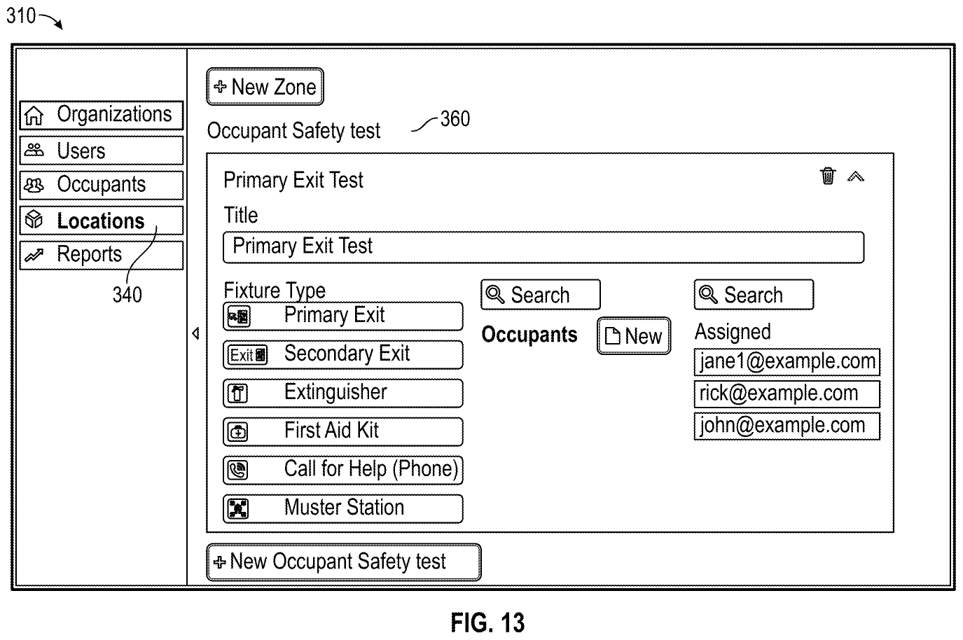

After creating the occupant safety test, method 250 moves to step 270. At step 270, system 110 sends or transmits the occupant safety test created to the occupant. In order to transmit the occupant safety test to the occupant, system 110 prompts the administrator to enter the email address of the occupants required to take the occupant safety test. FIG. 13 shows screenshot 310 illustrating an example in which the occupant safety test 360 is created and sent to the occupant. In one example, the occupant safety test is transmitted to the occupant via an email address of the occupant. In another example, system 110 generates a link i.e., Uniform Resource Locator (URL) with the details of the occupants such that the occupants can access system 110 using the link containing the occupant safety test. After sending or transmitting the link or email to the occupant to access or take the occupant safety test, method 250 ends at step 272.

After sending the link or email with the occupant safety test to the occupant, the occupant accesses the link or email by logging into system 110 with his details. In order to access system 110 using the link or email, the occupant uses user device 160.

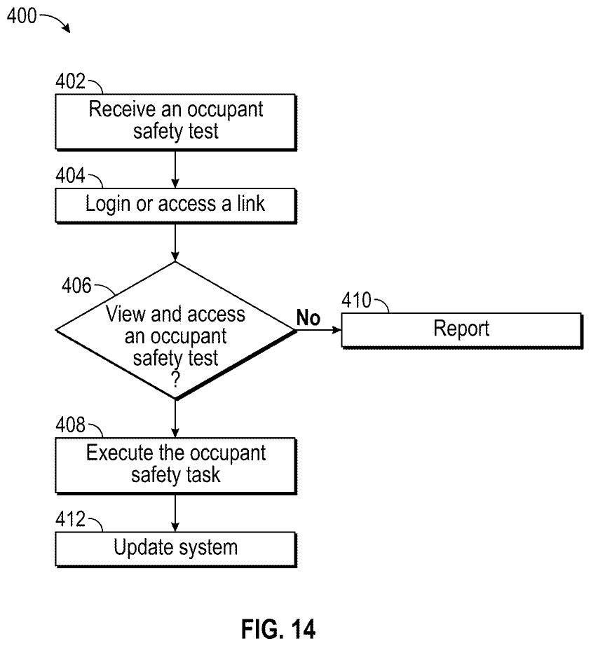

FIG. 14 shows a method 400 of receiving and executing the occupant safety test assigned, by an occupant, in accordance with one embodiment of the present invention. The order in which method 400 is described should not be construed as a limitation, and any number of the described method blocks can be combined in any order to implement method 400 or alternate methods. Additionally, individual blocks may be deleted from method 400 without departing from the spirit and scope of the subject matter described herein. Furthermore, method 400 can be implemented in any suitable hardware, software, firmware, or combination thereof. However, for ease of explanation, in the embodiments described below, method 400 implements using the above-described user device 160.

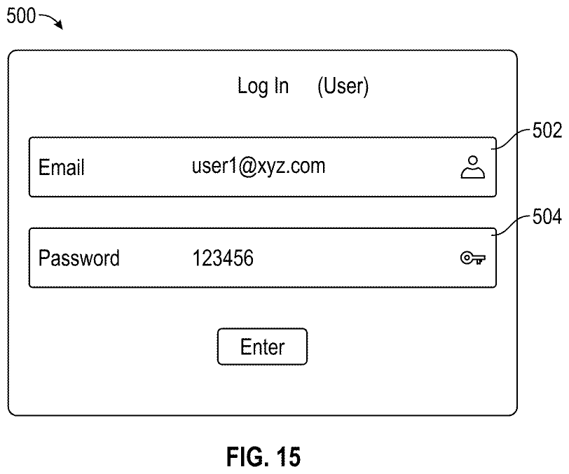

At step 402, the occupant receives the occupant safety test assigned to him from system 110. After receiving, the occupant uses his user device 160 to login to system 110 or access the link using a third party web browser, as shown at step 414. FIG. 15 shows an exemplary login page or dialog box 500 prompted to the occupant by user device 160 to login to system 110 to access the link or email. As can be seen, login page 500 includes subsections 502 and 504 for receiving the email address and password, respectively from the occupant. Upon being prompted, the occupant provides his email address and password registered with system 110 to access system 110.

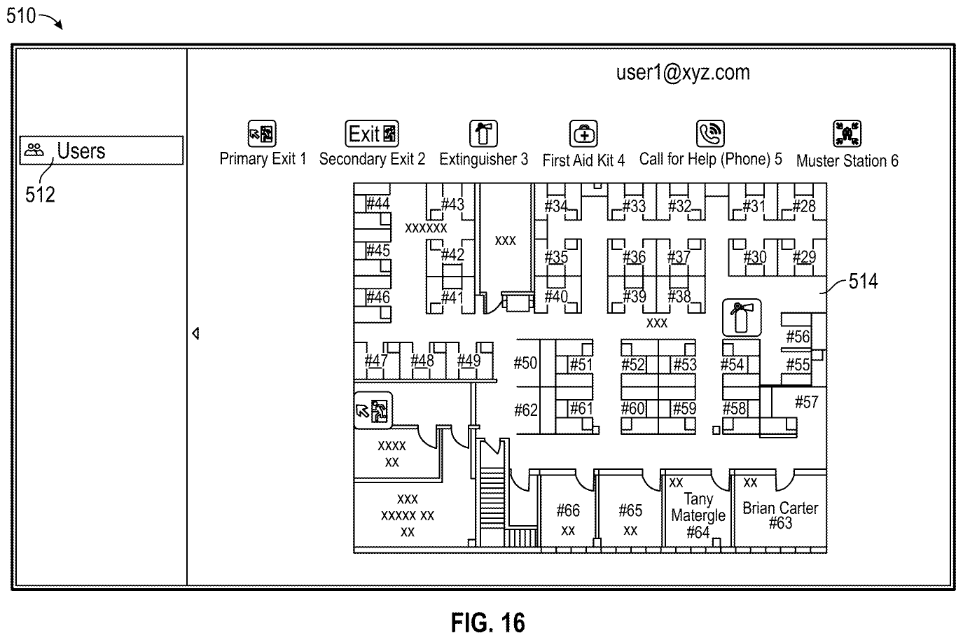

Subsequently, user device 160 checks whether the occupant is able to view and access the occupant safety test assigned to him. If the occupant is able to view and access the occupant safety test assigned to him, then the occupant safety test assigned to him gets displayed such that the occupant can access and execute the occupant safety test, as shown at step 408. FIG. 16 shows screenshot 510 showing a subsection 512, displaying occupant safety test 514 in which the occupant is prompted to identify the safety fixtures in the zone. When the occupant safety test is being executed, the user identifies the safety fixtures on the zone plan of the zone and gets familiarized with the physical location of the fixtures corresponding to the placement of the safety fixtures on the zone plan.

If the occupant is not able to view or access the link to the occupant safety test at step 406, then the occupant reports to the administrator operating system 110 to allow him to access the occupant safety test.

It should be understood that the occupant safety test is created and assigned for new occupants or existing occupants. In one implementation, the system configures to automatically create the occupant safety test periodically e.g., once in three months such that the occupants are familiarized with all safety fixtures even if any physical change is made to the fixture in the zone.

Based on the above, it is evident that the occupant safety test is assigned for each occupant of an organization in every location. By assigning the occupant safety test to each occupant in the organization, each occupant gets familiarized with the safety fixtures in the zone, which the occupant can utilize in an emergency situation to ensure his safety.

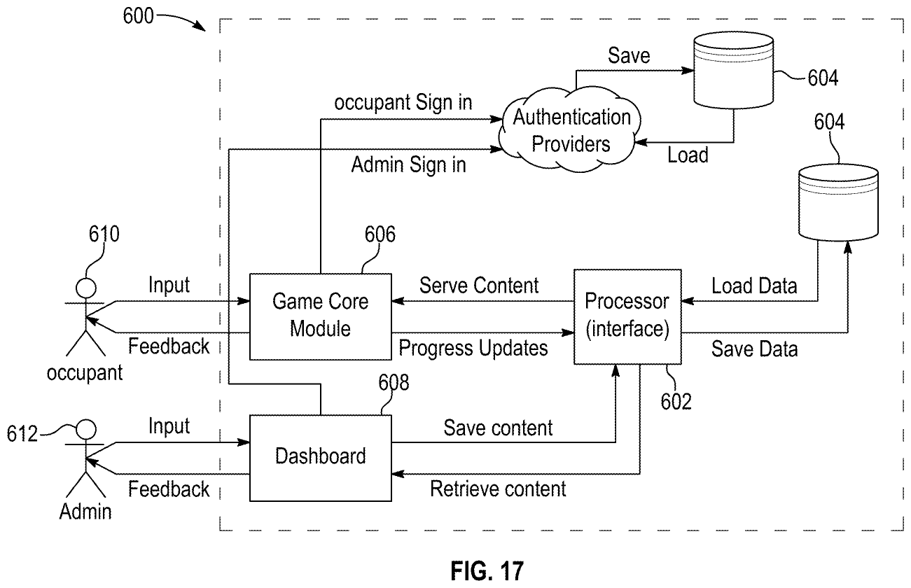

FIG. 17 shows system 600 for creating an occupant safety test, in accordance with one embodiment of the present invention. Here, system 600 implements similar to system 100 as explained above. System 600 implements as a standalone device or in a client-server architecture. System 600 includes processor 602. Processor 602 includes any suitable processing device, such as a microprocessor, microcontroller, integrated circuit, logic device, or other suitable processing device. In one example, processor 602 includes an interface (application programming interface (API)) that allows user i.e., occupant 610 and/or administrator 612 to interact with system 600.

Processor 602 communicatively connects to memory 604. Memory 604 includes computer-readable media, including, but not limited to, a non-transitory computer-readable media, RAM, ROM, hard drives, flash drives, or other memory devices. In one example, memory 604 includes a database that stores occupant(s) and administrator details including, but not limited to, occupant(s) login details, administrator details, occupant test data, occupant test/game level and reward data among other details.

System 600 includes game core module 606. In one implementation, game core module 606 forms a part of memory 604. In another implementation, game core module 606 operates as a separate module. Game core module 606 in conjunction with processor 602 creates occupant safety tests such as germ safe tests, occupant exit tests, and safety check tests.

System 600 includes dashboard 608. Dashboard 608 indicates a display (e.g., display panel) that retrieves and displays data from memory 604 and/or game core module 606 upon receiving instructions from processor 602.

As specified above, occupant 610 indicates a person employed or present in one or more zones in a location of the organization. In one example, occupant 610 indicates an employee of the organization assigned with a designated workstation to perform a designated task. In another example, occupant 610 indicates a visitor or guest visiting a zone for a specific duration. In the current implementation, administrator 612 includes a management of the structure or a security/safety manager responsible for safety and security of occupants 610 in the structure. Administrator 612 creates the plurality of courses for occupants 610 depending on their zones and/or level of training required to get them familiarized with the fixtures or safety equipment or safety protocols to be followed in an emergency in the structure. In one example, administrator 612 obtains employee data and visitor's data and creates the occupant safety tests. Here, a visitor includes a guest or contractor or a delivery agent who visits the structure for a short period of time. Here, administrator 612 creates occupant tests such as safety tests, occupant exit tests and safety checks such that occupants 610 can get familiarized with zones, safety equipment, fixtures and safety incidents (including scenarios/image previews such as use of fire alarms, for example) placed at various locations in the zones of a structure (e.g., building).

Occupant 610 logs in and accesses system 600 and takes the occupant tests. A person skilled in the art understands that occupant 610 and/or administrator 612 uses their respective user devices (not shown) such as mobile phone, laptop or other electronic devices to interact with system 600. When occupant 610 interacts with system 600, game core module 606 receives input from occupant 610 and sends the input to processor 602. Processor 602 processes the input and stores data i.e., output in memory 604. Further, processor 602 provides feedback such as success or failure or additional data in response to the input received from occupant 610 via game core module 606.

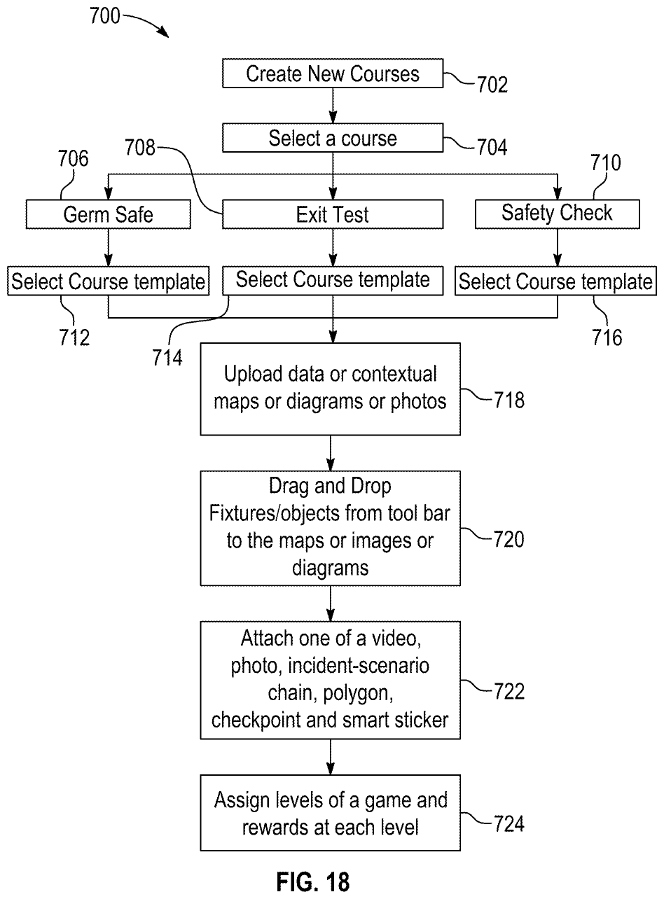

A method of creating occupant safety tests for occupants to take and get familiarized with fixtures, safety equipment, scenarios, etc. is explained using FIG. 18. FIG. 18 illustrates method 700 of creating occupant safety tests, in accordance with one embodiment of the present invention. The order in which method 700 is described should not be construed as a limitation, and any number of the described method blocks can be combined in any order to implement method 700 or alternate methods. Additionally, individual blocks may be deleted from method 700 without departing from the spirit and scope of the subject matter described herein. Furthermore, method 700 can be implemented in any suitable hardware, software, firmware, or combination thereof. However, for ease of explanation, in the embodiments described below, method 700 implements using the above-described system 600.

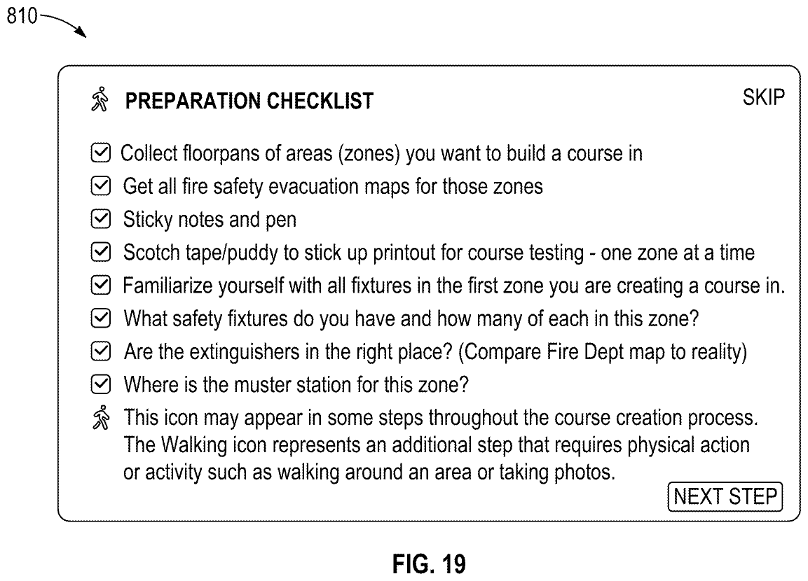

At first, system 600 creates new courses for the occupant safety test, as shown at step 702. In one example, system 600 allows administrator 612 to create a plurality of courses. A person skilled in the art understands that system 600 creates new courses or selects a course from existing courses. Here, system 600 creates the plurality of courses for each zone and/or entire structure depending on the need. At the time of creating new courses, system 600 presents a checklist to administrator 612 such that all details of the zone, fire safety evacuation maps, fixtures, and other information is accurate. FIG. 19 shows an exemplary screenshot 810 showing preparation checklist presented to administrator 612. Administrator 612 checks all boxes indicating that all information corresponding to the courses are fed to system 600 and is accurate.

In the present embodiment, a course indicates a training material or training test that is created for occupants 610 to get familiarized with virtual and/or physical fixtures location in the structure, incidents and safe from germs. In accordance with one embodiment, system 600 creates courses for a germ safe test, an occupant exit test, a safety check test and so on. The germ safe test indicates a test prepared for ensuring hygiene of occupants 610 in the structure. For example, the germ safe test includes a sequence of steps that occupant 610 has to follow to wash his/her hands in a washbasin. Here, system 600 presents an onboarding screen with one or more photos to occupant 610 on his user device. Occupant 610 hovers over the screen on the virtual floor map and identifies/locates/taps the germ spots, such as plastic/steel/glass/wood surface germ spots. Optionally, hovering over germ spots displays standard operating protocols (SOPs) such as maintaining social distancing, staying away from other persons sneezing, etc.

An occupant exit test indicates a test prepared for ensuring occupant's familiarization with zones in the structure and/or placement and use of fixtures and safety equipment (e.g., first aid kit) in the structure. For example, the occupant exit test includes a fire exit test where occupant 610 is made to identify a primary exit door, followed by a secondary exit door and a muster station.

A safety check test indicates a test created for occupants to get familiarized with the visual indicators/legends/symbols corresponding to an incident. In other words, the safety check test indicates visual indicators created with which occupant 610 relates to an incident in the structure. The safety check test teaches occupants 610 vital information to help stay safe in the structure. In one example, the safety check test includes a game marker such as a Quick Response (QR) code placed at the entrance of a zone. Here, occupant 610 scans the QR code and helps to discover the common workplace emergencies. In one example, the safety check test includes visual indicators for incidents such as “uncontained fire”, “minor injury”, “severe injury”, “evacuation”, “contained fire”, etc. The visual indicators corresponding to the safety check tests ensure occupants 610 are familiar with different symbols and can take necessary action/precaution depending on the type of incident when it occurs. In one example, occupant 610 provides feedback based on the information received from system 600. System 600 reviews the feedback and modifies the safety check test or the occupant safety test depending on the need.

After creating the courses, system 600 selects a course, as shown at step 704. System 600 selects one of germ safe (step 706), occupant exit test (step 708) and safety check (step 710). System 600 selects a course template (step 712; 714; 716) corresponding to selection made at steps 706, 708 and 710. In one example, system 600 selects a zone in the structure for creating the occupant safety test. Upon selection, system 600 prompts administrator 612 to upload data and/or contextual maps/diagrams/floor maps or photos of the zone, as shown in step 718. In one example, contextual maps/diagrams/floor maps or photos of the zone indicate virtual floor maps each of the zones in the structure. Further, system 600 prompts administrator 612 to enter details of the zone such as name and floor number, dimensions of the zone, etc. Further, system 600 allows administrator 612 to enter details of fixtures available in the zone.

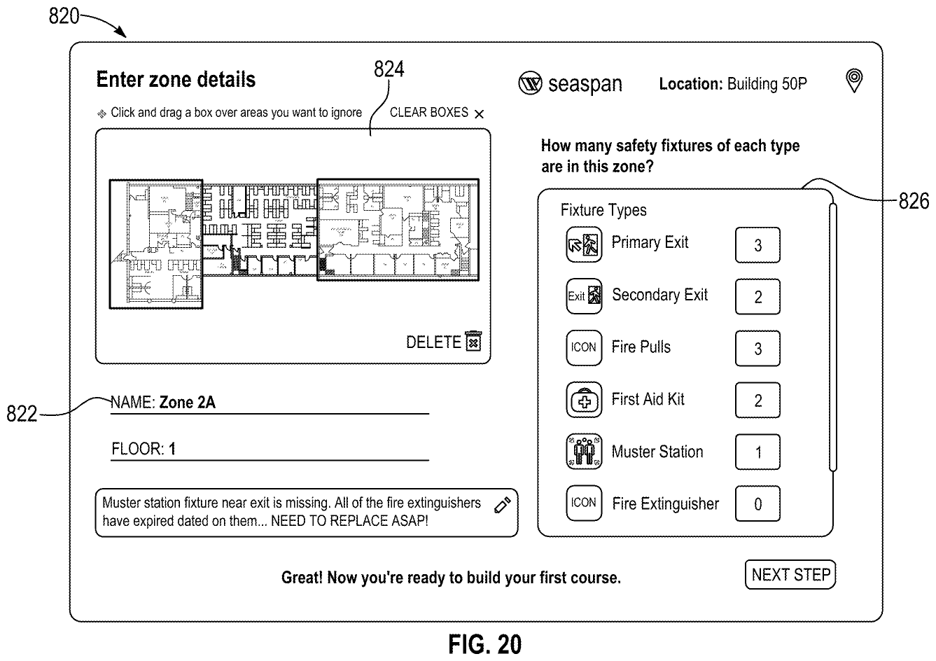

FIG. 20 shows screenshot 820 showing administrator 612 providing details of the zone to create an occupant test, in accordance with one exemplary embodiment of the present invention. As can be seen, system 600 presents first section 822 to provide name and floor details of the zone. Further, system 600 presents second section 824 to upload the contextual maps or diagrams i.e., virtual floor map of the zone. Furthermore, system 600 presents third section 826 for providing details of fixtures available in the zone. In one example, system 600 prompts administrator 612 to provide details of fixtures such as number and placement of primary exits, secondary exits, fire pulls, first aid kits, muster station and fire extinguishers available in the zone in third section 826.

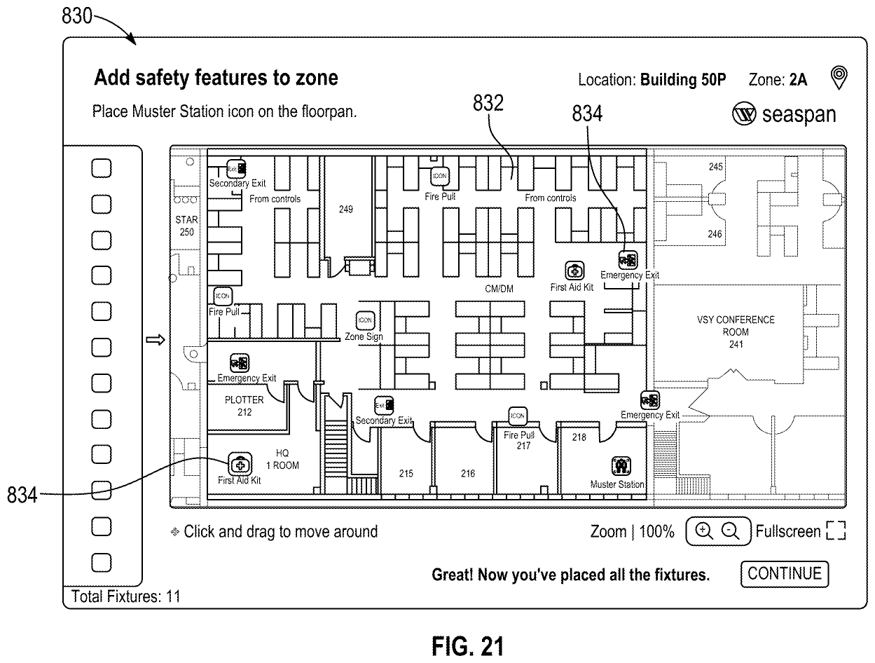

At step 720, system 600 prompts administrator 612 to drag and drop virtual fixtures or objects from a toolbar over the contextual maps or diagrams selected at step 718. FIG. 21 shows screenshot 830 showing administrator 612 adding virtual fixtures to the contextual maps i.e., floor map of the zone, in accordance with one exemplary embodiment of the present invention. As can be seen, system 600 presents first section 832 to include a floor map of the zone. Subsequently, system 600 prompts administrator 612 to add virtual fixtures 834 such as primary exits, secondary exits, fire pulls, first aid kits, muster station and fire extinguishers on the floor map of the zone.

At step 722, system 600 prompts administrator 612 to attach a game marker beside or over the virtual fixture or safety equipment on the virtual floor map. The game marker includes a virtual sticker with different shapes and form factors indicating different types of fixtures or safety equipment on the virtual floor map. Alternatively, the game marker includes a physical sticker that is affixed beside the fixture or safety equipment physically. The game marker stores information corresponding to the virtual fixtures or objects for each of the germ safe test, the occupant exit test, and the safety check test. Occupant 610 scans the game marker with his user device for initializing the game for occupant 610 to get familiarized with fixture or safety equipment or incident scenarios in the structure.

In one example, the game marker includes one of a video, a photo, an incident scenario chain, a polygon, a checkpoint, a smart sticker, a Quick Response (QR) code, and a Uniform Resource Locator (URL). Here, the video includes an URL embedded into the game marker for triggering playing of a video to educate or train occupant 610 about the occupant safety test and get familiarized with the zone and fixtures and/or incidents. The photo indicates an image or object corresponding to a certain fixture e.g., fire extinguisher. Incident scenario chain indicates a selection of photos or visual indicators corresponding to an event such as evacuation from the building in case of a fire accident or reacting to a scenario occurred such as an accident or injury in the structure. In one example, the event includes, but not limited to, finger cut, burn, headache, finger cut off, broken wrist, allergic reaction, printer fire, microwave fire, wastebasket fire, fire alarm, outlet fire, kitchen fire, office filling with smoke and so on. The incident scenario allows occupants 610 to quickly identify the seriousness of any unforeseen situation and take necessary action based on applicable protocols. This minimizes the occupants' reaction time to address any situation in the zone/structure. Polygon indicates a symbol or clickable area on the virtual floor map such as a photo or map. Occupant 610 clicks on the polygon to get information corresponding to the fixture, for example. Smart sticker indicates a virtual sticker having a link (URL) to an external source for providing specific training to occupant 610.

In one example, the game marker includes a Quick response (QR) code that is placed beside any fixture that occupant 610 scans and takes the occupant safety test. For example, a QR code is placed next to a primary door physically. Occupant 610 scans the QR code and initiates playing the game. From the above, a person skilled in the art understands that the game marker indicates virtual or physical stickers having a different shape for easily identifying a zone or safety equipment on the virtual floor map or physical location. In one example, the game markers are placed beside zone plaques on location for identifying the zone. In another example, the game markers are color coded for easy identification. In one example, scanning the game marker plays a video showing how to operate a safety equipment. When occupant 610 scans the game marker such as the QR code, then system 600 prompts him to position his phone over a primary door, and move to a secondary door followed by a muster station.

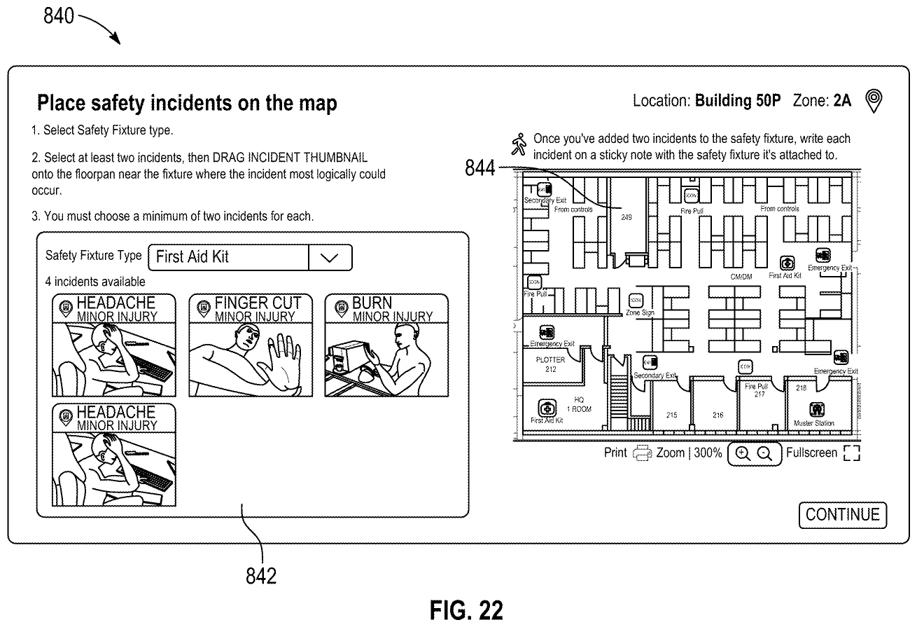

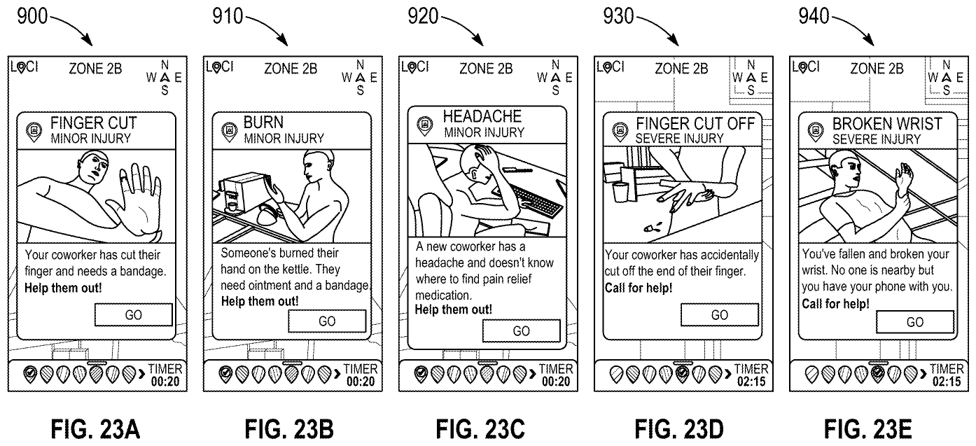

FIG. 22 shows screenshot 840 showing administrator 612 placing safety incidents on the map, in accordance with one exemplary embodiment of the present invention. As can be seen, system 600 presents first section 842 to place safety incidents type for each of the safety fixtures. FIGS. 23A through 23E show different safety incidents, in accordance with exemplary embodiment of the present invention. FIGS. 23A, 23B, 23C, 23D and 23E show screenshots 900, 910, 920, 930 and 940 for safety incidents such as finger cut, burn, headache, finger cut off, broken wrist, respectively. In one example, administrator 612 selects a safety incident e.g., “finger cut” corresponding to the safety fixture, say first aid kit in first section 842, as shown in FIG. 22. After selecting the safety incident, administrator 612 places the virtual fixture corresponding to the safety incident on the map in second section 644.

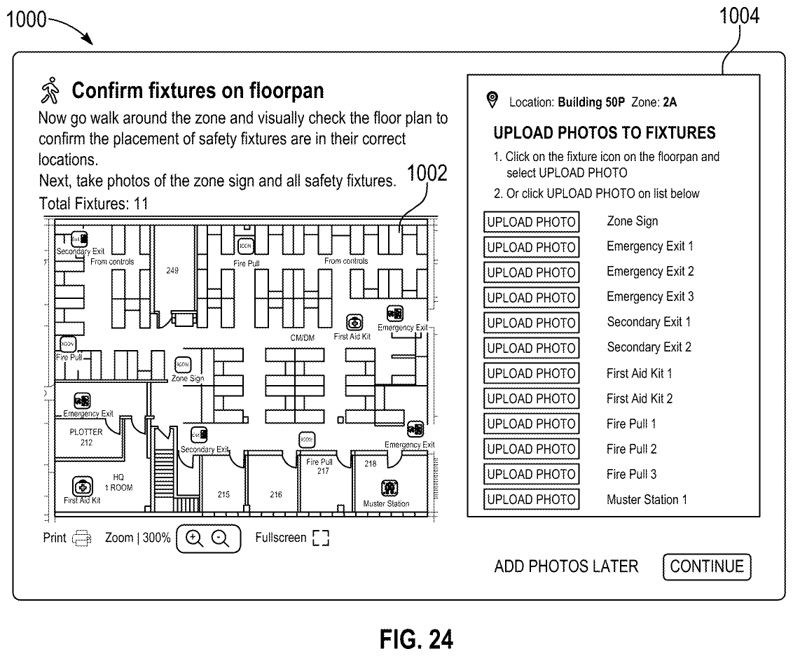

FIG. 24 shows screenshot 1000 that system 600 prompts administrator 612 to confirm fixtures placed on the contextual map (virtual map) with that of the actual physical zone/floor and upload corresponding photos to aid occupants 610 at the time of taking the occupant safety test, in accordance with one exemplary embodiment of the present invention. Screenshot 1000 includes first section 1002 having the contextual map of the zone in which administrator 612 places the fixtures. In one example, system 600 prompts administrator 612 to walk around the zone and visually check the floor plan to confirm placement of the safety fixtures. Subsequently, system 600 prompts administrator 612 to take pictures/photos of the zone sign and all safety fixtures at second section 1004 and upload them to memory 604.

At step 724, system 600 prompts administrator 612 to assign gamification techniques to each occupant safety test. In other words, system 600 prompts administrator 612 to create a game with multiple levels for each occupant safety test. For example, consider administrator 612 creates a game having several levels, say germ safe test as first level, occupant exit test in which occupant has to identify primary exit door, secondary exit door and muster station as second level and safety check test as third level. For each level, administrator 612 assigns a score or reward that is awarded to occupant 610 up on successfully completing/identifying while taking the occupant test (game). In one implementation, within each level, system 600 allows administrator 612 to assign points or score or reward. The rewards include a coupon or other incentives that occupant 610 can use to purchase virtual points or to pay for goods/services from third-party websites/stores.

For example, consider administrator 612 creates an occupant exit test for identifying primary exit door, secondary exit door and muster station. Here, administrator 612 assigns points or score or reward for identifying each of the primary exit door, secondary exit door and muster station such that the points are awarded to occupant up on successfully completing/identifying them while taking the occupant safety test. In another example, administrator 612 assigns points or score or reward for identifying fixtures at different levels such that the points are awarded to occupant up on successfully completing/identifying them while taking the occupant safety test. System 600 helps to create the occupant safety tests with different levels and assign points to encourage occupants 610 to participate in learning and getting familiarized with fixtures, germ safe/hygiene and safety checks in the zone. This reduces the time taken by occupants 610 to reach to safety in case of an emergency such as fire accident or to reach the first aid kit when a person gets injured in the zone.

After creating the occupant tests, system 600 stores the information in memory 604. Further, system 600 transmits the information corresponding to the occupant tests to user devices of occupants 610 in the structure.

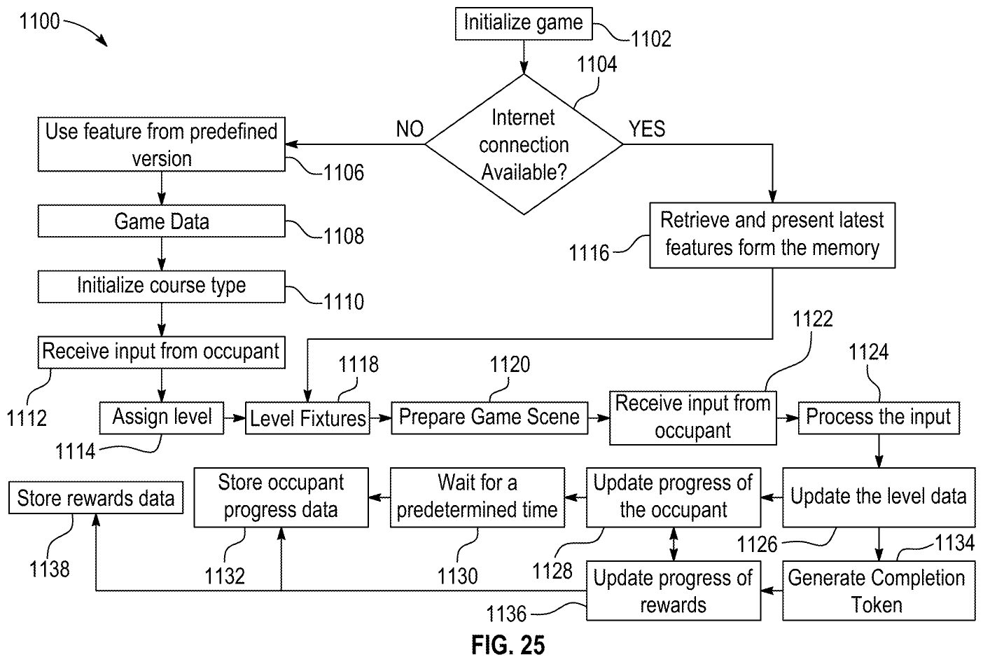

Now, referring to FIG. 25, method 1100 of executing the occupant safety test, by occupant 610 is explained, in accordance with one embodiment of the present invention. The order in which method 1100 is described should not be construed as a limitation, and any number of the described method blocks can be combined in any order to implement method 1100 or alternate methods. Additionally, individual blocks may be deleted from method 1100 without departing from the spirit and scope of the subject matter described herein. Furthermore, method 1100 can be implemented in any suitable hardware, software, firmware, or combination thereof. However, for ease of explanation, in the embodiments described below, method 1100 implements using the above-described system 600.

At step 1102, occupant 610 takes the occupant test using his/her user device such as a mobile phone. Occupant 610 takes the occupant test by initializing the game. In one example, occupant 610 scans the smart sticker placed virtually beside a fixture on the contextual map. Optionally, occupant 610 scans the QR code placed beside a fixture such as a fire extinguisher to initialize the game. As specified above, administrator 612 creates the occupant safety test having levels and scores thereby making the occupant safety test a game of skill for occupant 610. At step 1104, the user device checks whether it is connected to the internet. If the user device is not connected to the internet, then method 1100 moves to step 1106. As specified above, system 600 transmits the information corresponding to the occupant safety tests to the user devices of occupants 610 in the structure. When the internet connection is not available, the user device uses the features from a predefined version stored in its memory, as shown at step 1106. At step 1108, the user device retrieves the game data from the memory. At step 1110, occupant 610 initiates/selects the course type. As specified above, the course type includes germ safe test, occupant exit test and safety check test. At step 1112, the user device receives an input corresponding to the selection of occupant 610. At step 1114, the user device assigns a level in the game based on the information stored in its memory. Further, the user obtains the fixtures corresponding to the level he played last.

If the internet connection is available at step 1104, then method 1100 moves to step 1116. At step 1116, the user device connects to system 600, retrieves and presents the latest features from system 600. Here, system 600 checks the data from memory 604 and assigns a level and corresponding virtual fixtures which occupant 610 has to identify as part of the game.

Further, system 600 transmits and prepares a game scene on the user device, as shown at step 1120. The game scene indicates a scenario in which system 600 picks for occupant to identify the game marker and get familiarized with corresponding physical location of the fixtures or safety equipment or incidents in the structure. Occupant 610 provides an input and system receives (step 1122) the input from the user device. For example, consider that the user device receives and prompts “fire alarm” scenario/game to occupant 610 to participate in the game and show his familiarization of the primary exit door, the secondary exit door and the muster station in the structure. Here, occupant 610 selects and proceeds to provide information/selection of the primary exit door, the secondary exit door and the muster station on the contextual map. Upon selection, the user device transmits the input to system 600. Subsequently, system 600 processes (1124) the input and updates the level of game (step 1126). Further, system 600 updates the progress (step 1128) of occupant 610 in the game as he successfully identifies the fixtures. In one implementation, system 600 waits for a predetermined time (step 1130) and stores the progress of the occupant 610 (step 1132). When occupant 610 completes a level at step 1126, system 600 generates a completion token (step 1134) and presents it to occupant 610 on his user device. Presenting the token up on completion of the level motivates the occupant 610 to continue the game and get familiarized with the fixtures, safety checks and scenarios in the structure. When system 600 presents the token to occupant 610, system 600 updates the progress of rewards gained by occupant 610 (step 1136) and stores the data in memory (step 1138). Method 1100 ends at step 1138.

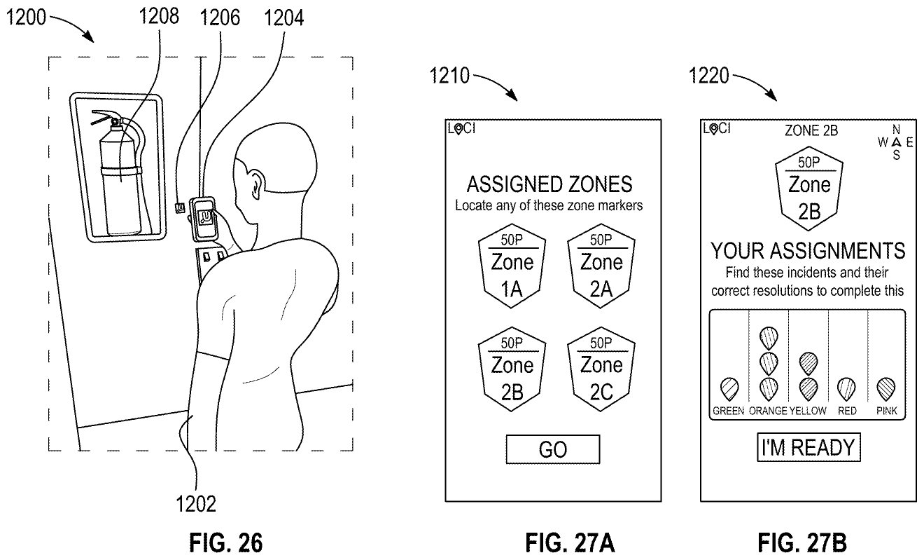

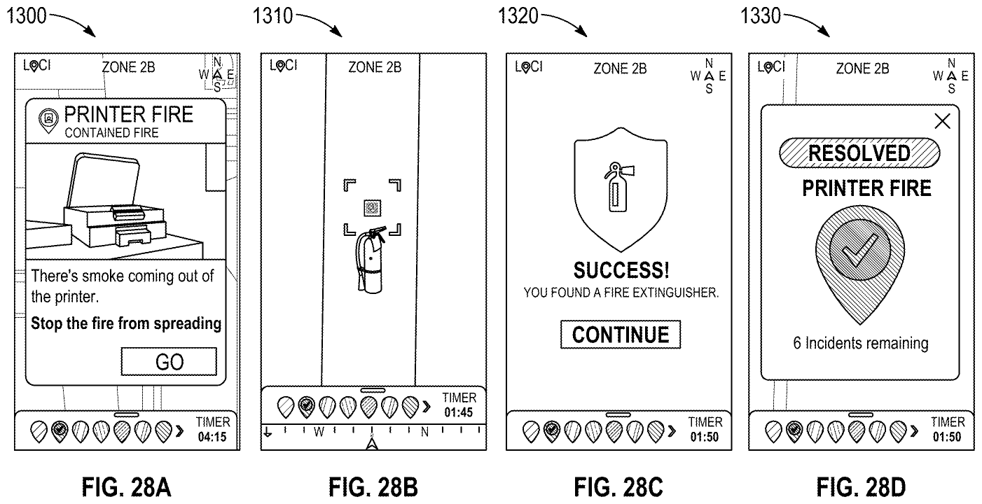

FIGS. 26 through 30H show exemplary screenshots illustrating different embodiments of method 1100 explained above. FIG. 26 shows an environment 1200 in which occupant 1202 uses his user device 1204 to scan QR code 1206 placed beside fire extinguisher 1208. Upon scanning, user device 1204 captures and transmits QR code 1206 to system 600. System 600 identifies smart sticker 1206 and prompts occupant 1202 to select a zone. FIG. 27A shows exemplary screenshot 1210 where system 600 prompts occupant 1202 to select a zone. Upon selection, system 600 prompts occupant 1202 to select an assignment/test. FIG. 27B shows exemplary screenshot 1220 showing prompt presented to occupant 1202 on his user device 1204 to select an assignment/test. Assume that occupant 1202 selects an incident such as “contained fire” at printer fire. System 600 prompts occupant 1202 to point user device 1204 to locate a fire extinguisher near the printer. Here, occupant 1202 points user device 1204 to the smart sticker placed beside the printer to confirm the location of the fire extinguisher. If system 600 determines that location of the smart sticker corresponds to the location stored in memory 604, then system 600 displays a success message and presents a reward to occupant 1202 for successful completion of the test.

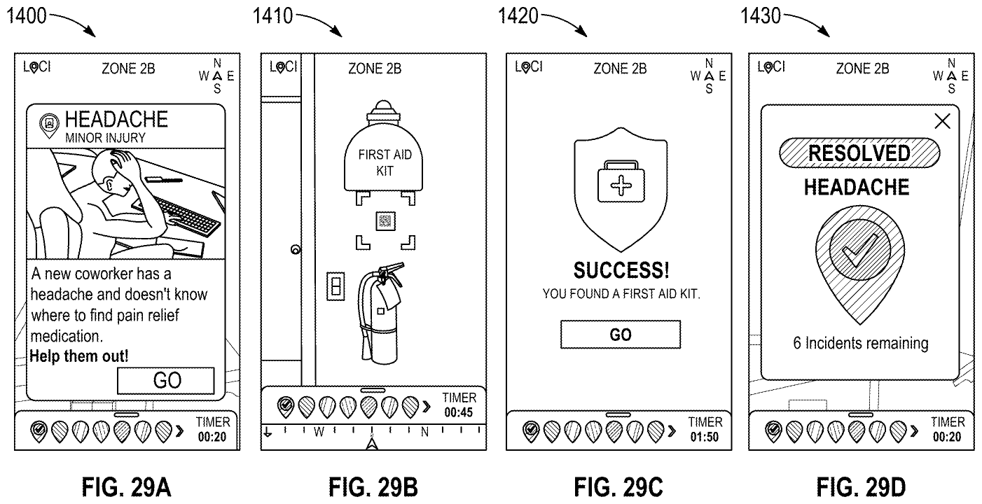

FIGS. 28A through 28D illustrate the above example. FIG. 28A shows exemplary screenshot 1300 in which system 600 prompts an incident to occupant 1202. FIG. 28B shows exemplary screenshot 1310 in which occupant 1202 points user device 1204 to the smart sticker placed beside the printer to confirm the location of the fire extinguisher on the contextual map. FIG. 28C shows exemplary screenshot 1320 in which system 600 displays a success message up on occupant 1202 identifying the location of the fire extinguisher. FIG. 28D shows exemplary screenshot 1330 in which system 600 presents a reward to occupant 1202 for successful completion of the test.

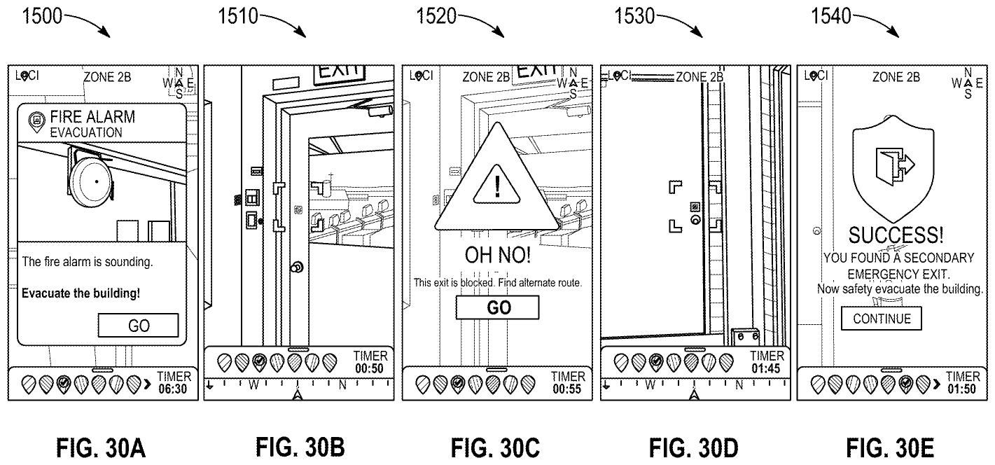

FIGS. 29A through 29D illustrate another example in which occupant 1202 successfully completes a test based on an incident. FIG. 29A shows exemplary screenshot 1400 in which system 600 prompts an incident to occupant 1202. In the present example, system 600 prompts occupant 1202 to find a first aid kit. Here, occupant 1202 points user device 1204 to the smart sticker placed beside the first aid kit. FIG. 29B shows exemplary screenshot 1410 in which occupant 1202 points user device 1204 to the smart sticker placed beside the first aid kit to confirm the location of the first aid kit on the contextual map. If system 600 determines that location of the smart sticker corresponds to the location stored in memory 604, then system 600 displays a success message and presents a reward to occupant 1202 for successful completion of the test. FIG. 29C shows exemplary screenshot 1420 in which system 600 displays a success message up on occupant 1202 identifying the location of the beside the first aid kit to confirm the location of the first. FIG. 29D shows exemplary screenshot 1430 in which system 600 presents a reward to occupant 1202 for successful completion of the test.

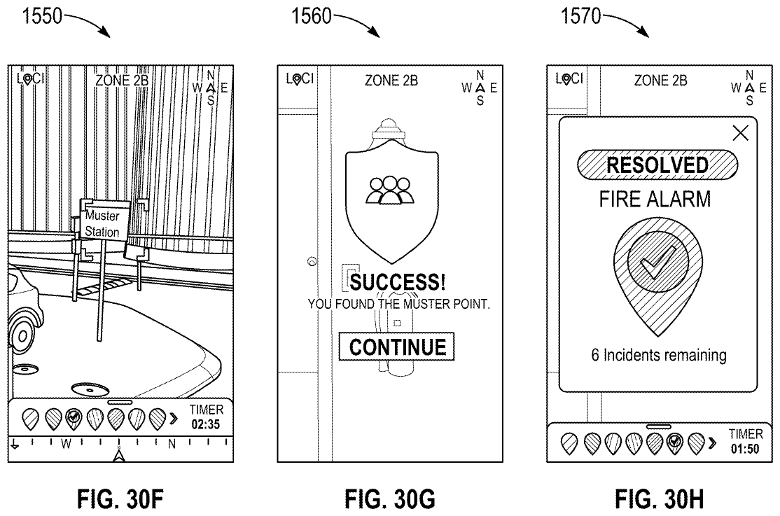

FIGS. 30A through 30H illustrate another example. FIG. 30A shows exemplary screenshot 1500 in which system 600 prompts an incident such as “fire alarm” to occupant 1202. Here, system 600 prompts occupant 1202 to identify the primary exit door, secondary exit door and muster station. Upon prompting, occupant 1202 walks to a door and scans the smart sticker placed beside the door as shown in screenshot 1510 in FIG. 30B. If the door is not identified as the primary exit door, then system 600 displays an error message as shown in screenshot 1520 in FIG. 30C. In such a case, occupant 1202 walks to another door and scans the smart sticker placed beside the door, as shown in screenshot 1530 in FIG. 30D. If the smart sticker scanned indicates that the location is correct, then system 600 displays a success message as shown in screenshot 1540 in FIG. 30E. Further, system 600 prompts occupant 1202 to identify muster station i.e., smart sticker beside the muster station as shown in screenshot 1550 in FIG. 30F. Here, If the location of the muster station is correct, then system 600 displays a success message as shown in screenshot 1560 in FIG. 30G. Further, system 600 presents a reward to occupant 1202 for successful completion of the test as shown in exemplary screenshot 1570 in FIG. 30H.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs.

Further, certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in figures are provided for illustrative purposes only and should not be construed in a limited sense. A person skilled in the art will appreciate alternate components that might be used to implement the embodiments of the present invention and such implementations will be within the scope of the present invention.

While preferred embodiments have been described above and illustrated in the accompanying drawings, it will be evident to those skilled in the art that modifications may be made without departing from this invention. Such modifications are considered as possible variants comprised within the scope of the invention.

What is claimed is:

1. A method of creating and executing an occupant safety test, the method comprising:
creating, by a processor, an occupant safety test comprising a plurality of courses, the plurality of courses comprising a germ safe test, an occupant exit test, a safety check test, the germ safe test indicating a test created for ensuring hygiene of occupants in each zone of a structure, the occupant exit test indicating a test created for ensuring occupant's familiarization of zones and placement of fixtures and safety equipment in the structure, and the safety check test indicating visual indicators created with which the occupants relates to an incident in the structure;
adding, by the processor, contextual maps or diagrams corresponding to the physical zone and the fixtures in each zone of the structure;
adding, by the processor, virtual fixtures or objects over the contextual maps or diagrams of the zone, wherein the virtual fixtures or objects are added for each of the germ safe test, the occupant exit test, and the safety check test;
attaching, by the processor, a game marker beside the virtual fixtures or objects, wherein the game marker stores information corresponding to the virtual fixtures or objects for each of the germ safe test, the occupant exit test, and the safety check test;
transmitting, by the processor, the occupant safety test created to the occupant; and
executing, by the processor, the occupant safety test by identifying the game marker to get familiarized with corresponding physical location of the fixtures or safety equipment or incidents in the structure.

2. The method of claim 1, further comprising creating a game having levels for each of the germ safe test, the occupant exit test, the safety check test.

3. The method of claim 2, further comprising assigning rewards or tokens upon the occupant successfully identifying the game marker at each level of the game.

4. The method of claim 3, further comprising updating data corresponding to occupant's progress in successfully identifying the game markers at each level of the game.

5. The method of claim 3, wherein the rewards or tokens are assigned based on the time taken for the occupant to identify the game marker at each level of the game.

6. The method of claim 1, further comprising presenting a game scene corresponding to the virtual fixtures or objects over the contextual maps or diagrams for execution of the occupant safety test.

7. The method of claim 6, further comprising scanning the game marker for initiating the execution of the occupant safety test.

8. The method of claim 1, further comprising color coding the game marker for identification of the zones and or fixtures in the structure.

9. A system for creating and executing an occupant safety test, the system comprising:
a processor; and
a memory coupled to the processor, wherein the processor is configured to execute program instructions stored in the memory, to:
create an occupant safety test comprising a plurality of courses, wherein the plurality of courses comprises a germ safe test, an occupant exit test, a safety check test, wherein the germ safe test indicates a test created for ensuring hygiene of occupants in each zone of a structure, wherein the occupant exit test indicates a test created for ensuring occupant's familiarization of zones and placement of fixtures and safety equipment in the structure, and wherein the safety check test indicates visual indicators created with which the occupants relates to an incident in the structure;
add contextual maps or diagrams corresponding to the physical zone and the fixtures in each zone of the structure;
add virtual fixtures or objects over the contextual maps or diagrams of the zone, wherein the virtual fixtures or objects are added for each of the germ safe test, the occupant exit test, and the safety check test;
attach a game marker beside the virtual fixtures or objects, wherein the game marker stores information corresponding to the virtual fixtures or objects for each of the germ safe test, the occupant exit test, and the safety check test;
transmit the occupant safety test created to the occupant; and
execute the occupant safety test by identifying the game marker to get familiarized with corresponding physical location of the fixtures or safety equipment or incidents in the structure.

10. The system of claim 9, wherein the processor executes the program instructions to create a game having levels for each of the germ safe test, the occupant exit test, and the safety check test.

11. The system of claim 10, wherein the processor executes the program instructions to assign rewards or tokens upon the occupant successfully identifying the game marker at each level of the game.

12. The system of claim 11, wherein the processor executes the program instructions to update data corresponding to occupant's progress in successfully identifying the game markers in each level.

13. The system of claim 11, wherein the processor assigns the rewards or tokens based on the time taken for the occupant to identify the game marker at each level of the game.

14. The system of claim 9, wherein the processor executes the program instructions to present a game scene corresponding to the virtual fixtures or objects over the contextual maps or diagrams for execution of the occupant safety test.

15. The system of claim 14, wherein the processor executes the program instructions to scan the game marker for initiating the execution of the occupant safety test.

16. The system of claim 9, wherein the processor executes the program instructions to color code the game marker for identification of the zones and or fixtures in the structure.

17. The system of claim 9, wherein the game marker comprises one of a photo, an incident-scenario chain, a polygon, a checkpoint, a smart sticker, a Quick Response (QR) code, and a Uniform Resource Locator (URL).

18. A non-transitory computer readable medium embodying a program executable in a computing device for creating and executing an occupant safety test, the program comprising:
a program code for creating an occupant safety test comprising a plurality of courses, the plurality of courses comprising a germ safe test, an occupant exit test, a safety check test, the germ safe test indicating a test created for ensuring hygiene of occupants in each zone of a structure, the occupant exit test indicating a test created for ensuring occupant's familiarization of zones and placement of fixtures and safety equipment in the structure, and the safety check test indicating visual indicators created with which the occupants relates to an incident in the structure;
a program code for adding contextual maps or diagrams corresponding to the physical zone and the fixtures in each zone of the structure;
a program code for adding virtual fixtures or objects over the contextual maps or diagrams of the zone, wherein the virtual fixtures or objects are added for each of the germ safe test, the occupant exit test, and the safety check test;
a program code for attaching a game marker beside the virtual fixtures or objects, wherein the game marker stores information corresponding to the virtual fixtures or objects for each of the germ safe test, the occupant exit test, and the safety check test;
a program code for transmitting the occupant safety test created to the occupant; and
a program code for executing the occupant safety test by identifying the game marker to get familiarized with corresponding physical location of the fixtures or safety equipment or incidents in the structure.

19. The program of claim 18, further comprises a program code for creating a game having levels for each of the germ safe test, the occupant exit test, and the safety check test.

20. The program of claim 19, further comprises a program code for assigning rewards or tokens upon the occupant successfully identifying the game marker at each level of the game.
